(19) United States
(12) Patent Application Publication
(10) Pub. No.: US 2007/0038560 A1
(43) Pub. Date: Feb. 15, 2007

(54) Transaction payment system and processing

(76) Inventor: Carl Ansley, New York, NY (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/202,547

(22) Filed: Aug. 12, 2005

(51) Int. Cl. G06Q 40/00

(52) U.S. Cl. 705/39

(57) ABSTRACT

A transaction payment processing system and methods are provided. In an illustrative implementation, a transaction payment processing environment comprises a service bus environment operating one or more services/applications. The service bus environment further comprises a service bus environment program providing one or more instructions to the service bus environment to manage the cooperating service bus environment services/applications. The service bus environment services/applications are operable to perform various functions and operations including but not limited to transaction authorization, fraud detection, regulatory compliance, and voice/telephony transaction payment processing. Further, the transaction payment processing environment comprises one or more transaction payment processing engines operable to perform functions representative of transaction card and transaction account linkage using directed acyclic graphs, and zero sum accounting for transaction payment processing.

### FIELD OF INVENTION

The present invention relates to transaction payment processing and, more particularly, to transaction payment processing performed surrounding cashless payment.

### BACKGROUND

Transaction payment processing is ubiquitous to realize transactions given the various modalities of communication technologies and protocols. Taking on various forms, transaction payment processing encompasses numerous rituals that have become common place in the consumer world. From simple cash-based physical account reconciliation (e.g., a consumer paying for an item with cash and the merchant recording the sale) to complex multi-national electronic currency exchanges and transfers to reconcile a multi-party transaction, transaction payment processing is extensively utilized and relied upon. Included in the realm of transaction payment processing is the ability to process transaction payments surrounding cashless transactions (e.g., credit card transactions, debit card transactions, prepaid card transactions, loyalty card transactions, gift card transactions, etc.). In this context reliable, efficient, and accurate transaction payment processing becomes tantamount to the success of merchants and the satisfaction of consumers.

Several technologies have been developed to handle, manage, and process cashless transaction payments. Ranging from simple data input and management computing applications, to sophisticated transaction payment communications networks and transaction payment processing platforms, these technologies share the commonality of being able to reconcile a transaction payment representative of a transaction (e.g., merchant-to-consumer transaction, merchant-to-merchant transaction, consumer-to-bank transaction, and merchant-to-bank transaction). With current solutions, transactions can be reconciled against one or more accounts. Additionally, in the context of cashless payment transactions, current practices allow consumers, merchants, and banks to perform one or more portions of a transaction using a transaction card (e.g., credit card, debit card, spending account transaction card, etc.). The transactions themselves can be performed to purchase, barter, redeem, and distribute various products and services. It is not inconceivable to think that current cashless transactions can be performed for any type of regular cash-based transaction (e.g., purchase of products and services).

Additionally, the implementation of cashless transactions (and cashless transaction payment processing) have availed various value added services to cooperating parties that help to promote the use of a particular form of cashless transaction. For example, a particular issuing bank might offer a consumer the incentive of amassing a reward point or, in some instances, a currency percentage rebate for each currency unit spent using the bank's debit or charge card. In such scenario, the debit card and/or charge card can be branded by a sponsor such that the bank, although issuing the transaction card, does not receive the marketing equity associated with the distribution and use of the branded card. In this context, an airline might wish to promote loyalty among its consumer base. The airline can work with a bank to issue a transaction card (e.g., a credit card) having the airline's logo and brand. Additionally, the airline might structure a reward program so that a consumer receives a reward (e.g., a mile in a redemption account) for every currency unit transacted with the branded transaction card. Such loyalty programs through the use of transaction cards is prevalent across various industries having numerous sponsors.

Another result of the cashless transaction payment processing has been the development of pre-paid debit transaction cards. Pre-paid debit transaction cards operate to allow a sponsor (e.g., a bank, airline, employer, product vendor, etc.) to sponsor a card that is issued by a bank and is operable to be used as part of transactions using existing (and future planned) banking and credit carrier networks. The pre-paid debit transaction cards have one or more account associated with the pre-paid debit transaction card and can be administered by a transaction payment processor or the sponsor company through the transaction payment processors platform. The use of pre-paid debit transaction cards can be applied to numerous existing efforts as a modality of transaction payment (e.g., marketing campaigns, health care spending accounts, transportation spending accounts, incentive awards, flex spending accounts, etc.).

In the context of marketing campaigns, the pre-paid debit transaction card can be filled with a selected amount of currency and distributed to loyal customers as a loyalty reward (e.g., if a consumer buy four products from a Vendor A the consumer receives a Vendor A branded pre-paid debit transaction card having a selected currency amount). The transaction payment processor, in this scenario, can manage the program supporting this specific marketing campaign by distributing the pre-paid debit transaction cards on behalf of Vendor A (e.g., the sponsor), tracking the transactions performed by the various distributed pre-paid debit transaction cards, administering the accounts underlying the program (e.g., sponsor account, pre-paid debit transaction cards, bank accounts, etc.).

Similarly, the transaction payment processor (operating a transaction payment processing platform) can operate to administer and manage the various information relevant to pre-paid debit transaction cards associated with one or more flex spending account (FSA), health care spending account (HSA), or transportation spending account (TSA). In the context of FSA, HSA, and TSA programs, the transaction payment processor can operate to distribute the pre-paid transaction cards for such accounts and administer, authorize, manage, reconcile, and report on the various transactions performed using the FSA, HSA, and/or TSA pre-paid debit transaction card.

Current transaction payment processing systems and methods are generally designed and implemented using rigid and fixed transaction payment processing platform architectures. Stated differently, current practices surrounding the design and development of transaction payment platforms employ hard coded computing applications that are non-modular and non-robust. For example, current transaction payment platforms can consist of a one or two large computing applications that operate to process all of the functions surrounding a transaction, including authorization processing, fraud detection, regulatory compliance, account reconciliation, and accounting. Accordingly, should one or more of these function require updating (e.g., a new transaction authorization protocol is required by a cooperating bank), the one or two large computing applications are required to be updated and recompiled to allow for the implementation of the update. Such practice is extremely inefficient as significant resources (e.g., time, labor, and money lost for transactions not able to be processed according to the update) are expended to perform a single update. Moreover, with current conventions, a single bug in the large applications could persist through the entire application rendering trouble-shooting an arduous and costly exercise.

It is appreciated that current practices fall short of providing a robust, updateable, customizable, and scalable modular transaction payment processing platform and methods that allow for reliable, efficient, accurate, and secure transaction payment processing. With current practices and conventions, cashless transaction payment processing is relegated to one or more of the legacy type transaction payment processing platforms that require significant resources to maintain.

### SUMMARY

A transaction payment processing system and methods are provided. In an illustrative implementation, a transaction payment processing environment comprises a service bus environment. In this implementation, the service bus environment comprises one more service bus environment services/applications that perform one or more portions of a transaction payment processing. The service bus environment further comprises a service bus environment program providing one or more instructions to the service bus environment to manage the cooperating service bus environment services/applications.

In operation, the illustrative transaction payment processing environment can receive a request to perform at least one transaction payment processing, or a portion thereof. Responsive to the request the transaction payment processing request, the transaction payment processing environment cooperates with the service bus environment program to coordinate the requested processing among one or more service bus environment services/applications. The service bus environment services/applications are operable to perform various functions and operations including but not limited to transaction authorization, fraud detection, regulatory compliance, and voice/telephony transaction payment processing.

In another illustrative implementation, the transaction payment processing environment can comprise one or more transaction payment processing engines operable to perform functions representative of transaction card and transaction account linkage using directed acyclic graphs, and zero sum accounting for transaction payment processing.

Other features of the herein described systems and methods are further described below.

### BRIEF DESCRIPTION OF THE DRAWINGS

The transaction payment processing system and methods are further described with reference to the accompanying drawings in which:

FIG. 1 is a block diagram of an exemplary computing environment in accordance with an implementation of the herein described systems and methods;

FIG. 2 is a block diagram of an exemplary networked computing environment;

FIG. 3 is a block diagram of an illustrative transaction payment processing environment in accordance with the herein described systems and methods;

FIG. 4 is a block diagram of another illustrative transaction payment processing environment in accordance with the herein described systems and methods;

FIG. 5 is a block diagram showing the cooperation of cooperating parties of an illustrative transaction payment processing environment in accordance with the herein described systems and methods;

FIG. 6 is a block diagram showing the cooperation of cooperating parties of another illustrative transaction payment processing environment in accordance with the herein described systems and methods;

FIG. 7 is a block diagram of an illustrative transaction payment processing service bus environment architecture in accordance with the herein described systems and methods;

FIG. 8 is a block diagram of an illustrative transaction payment processing environment performing authorization processing in accordance with the herein described systems and methods;

FIG. 9 is a flowchart diagram showing the processing performed by an illustrative transaction payment processing system when performing authorization processing in accordance with the herein described system and methods;

FIG. 10 is a flowchart diagram showing other processing performed by an illustrative transaction payment processing system when performing authorization processing in accordance with the herein described systems and methods;

FIG. 11 is a block diagram of an illustrative transaction payment processing environment performing fraud detection and regulatory compliance in accordance with the herein described systems and methods;

FIG. 12 is a flowchart diagram of the processing performed by an illustrative transaction payment processing system when performing fraud detection in accordance with the herein described systems and methods;

FIG. 13 is a block diagram of an illustrative transaction payment processing environment performing voice and telephony technologies processing in accordance with the herein described systems and methods;

FIG. 14 is a flowchart diagram of the processing performed by an illustrative transaction payment processing system when performing voice and telephony technologies processing in accordance with the herein described systems and methods;

FIG. 15 is a block diagram of an illustrative transaction payment processing system performing card and account linking using illustrative directed acyclic graphs in accordance with the herein described systems and methods;

FIG. 16 is a block diagram of illustrative directed acyclic graphs for use in card and account linkages in accordance with the herein described systems and methods; and

FIG. 17 is a block diagram of an illustrative transaction payment processing system performing zero-sum accounting for transaction payments in accordance with the herein described systems and methods.

### DETAILED DESCRIPTION

Overview:

Transaction payment processing is prevalent surrounding the various transactions being performed between and among various cooperating parties. Whether it is a merchant selling a product and/or service to a consumer, or a business purchasing raw materials from a vendor, the underlying commonality is the ability to process the transaction using one of a number of modalities, i.e., cash, cashless payment, barter, etc. In the context of cashless transaction payments, there are currently various practices and conventions to realize a cashless transaction payment processing. Generally, a transaction card (or representation of a cashless transaction payment medium—e.g., a mobile phone, a personal digital assistant, a FOB wand, an Internet e-commerce account, etc.) is used to offer payment for a desired transaction. The information from the transaction card (or representation of a transaction medium) is processed by a transaction payment platform to complete one or more portions of a transaction payment processing transaction (e.g., transaction authorization, fraud detection, regulatory compliance, etc.).

Conventional transaction payment processing platforms, however, fall short of providing a dynamic, robust, easily updateable, scalable, reliable, and efficient transaction environment. Current practices are generally realized by transaction payment platforms having rigid, non-robust, and resource intensive transaction payment computing applications. Typically, current transaction payment platform computing applications are designed to be non-modular in nature, and moreover, generally contain most, if not all, of the features and operations used in transaction payment processing in one (or two at best) computing applications. As such, if one or more of the features require updating, the entire computing application is required to be updated and recompiled to reflect the new updates. It is appreciated that such practice is extremely inefficient and can introduce a degree of uncertainty and unreliability. Stated differently, if an update is implemented in conventional transaction payment platforms, it may be the case that such update can influence other features and operations of the all encompassing few computing applications and if such update is corrupt can cause the entire computing application to stop operating. Troubleshooting on this basis becomes an arduous and cumbersome task as the entire non-modular computer program is required to be debugged.

Moreover, with conventional platforms, scalability can become an issue. For example, with current practices the transaction payment processing computing application(s) is (are) designed and developed to handle a projected number of transactions/users/accounts, etc. Given the general, single or double application architecture, it is difficult to modify the architecture to accommodate significant increases in transactions/users/accounts than originally projected. In such case, a new application might have to be designed and developed to handle the increases in data processing. Such practice is costly both in expenditure of valuable development time. Additionally, lack of scalability can impact a transaction payment processor's bottom line as less transactions can be processed during a given time period (resulting from overloading.

Centralized transaction processing systems also suffer from an increase in the cost of hardware and software support services required to support single or dual application systems. Due to the centralized nature of such platforms, it is often necessary to host the application(s) within high-end (“big iron” or “mainframe”) environments to ensure that the necessary availability and capacity requirements are met.

The herein described systems and methods ameliorate the shortcomings of existing practices and conventions by providing a modular, robust, updateable, scalable, reliable, efficient, and dynamic transaction payment processing platform that allows for customization on various levels of processing granularity and is operable across one or more disparate computing environments. In an illustrative implementation a transaction payment processing environment having a service bus environment is provided. In this illustrative implementation, the service bus environment comprises one more service bus services/applications. These service bus environment services/applications are operable to perform various functions surrounding the processing of a transaction payment including, but not limited to, authorization, fraud detection, regulatory compliance, and telephony/voice-based transaction payment processing.

In operation, in the context of authorization processing an illustrative transaction payment processing environment can receive a request to authorize a transaction. Responsive to the authorization request, the transaction payment processing cooperates with an exemplary service bus environment having one or more service bus environment authorization services/applications. The service bus environment authorization service/application processes the request for authorization and returns to the transaction payment processing environment the results of the authorization check. The transaction payment processing environment, in turn, can communicate the results of such authorization check to one or more cooperating parties (e.g., other transaction payment processors, banks, end-users, merchants, etc.).

In an illustrative implementation, the authorization pipeline system can comprise a set of functional components, connected logically together as a pipeline, that processes payment network (e.g., Visa/MasterCard) transactions in real-time. Each component in the pipeline can represent a specific piece of logic that is applied to the processing of a transaction, and can be processed serially, in the order they are defined by the pipeline. The overall transaction processing logic can be controlled by parameter modifications to individual components, reorganization/insertion/deletion of components within the pipeline, and by creating script interceptors that add arbitrary logic to components.

In operation, in the context of fraud detection processing an illustrative transaction payment processing environment can receive a request to determine if a transaction is fraudulent. Responsive to the fraud detection request, the transaction payment processing cooperates with an exemplary service bus environment having one or more service bus environment fraud detection services/applications. The service bus environment fraud detection service/application processes the request for fraud detection and returns to the transaction payment processing environment the results of the fraud check. Included in the fraud detection check is a check of spending account limits, geography of the transaction, and transaction card information. The transaction payment processing environment, in turn, can communicate the results of such fraud detection check to one or more cooperating parties (e.g., other transaction payment processors, banks, end-users, merchants, etc.).

In an illustrative implementation, fraud detection can be realized by a Fraud Activity Determination System (FADS) that can comprise a set of scoring components, connected logically together as a container, that applies scoring logic to events in real-time. Each component in a container can represent a specific scoring function that can be applied to an event that is being processed. The individual scores can be combined and weighted to construct an overall score used by the FADS client (e.g. the Authorization Pipeline) to alter how the event in question is processed. The rule-based scoring can be controlled by parameter modifications to individual components, and the insertion or deletion of components within the FADS container.

Regarding regulatory compliance, an illustrative transaction payment processing environment can operate according to a selected set of regulatory compliance guidelines and regulations to generate data representative of transactions. In operation, the illustrative transaction payment processing environment can cooperate with a service bus environment regulatory compliance service/application to generate regulatory compliance data for one or more transactions. The transaction payment processing environment, in turn, can communicate the generated regulatory compliance data to one or more cooperating regulatory agencies or parties (e.g., banks, FBI, etc.).

In an illustrative implementation, regulatory compliance can be realized through a user verification system (UVS) that can be a set of technologies that ensure the operational compliance of prepaid programs with respect to laws and regulations such as Bank Secrecy Act (BSA) as amended by the US PATRIOT Act and other anti-money laundering regulations. In the implementation, it can provide a set of matching and scoring systems combined with third party integrations, for example credit bureaus and government departments such as Homeland Security. In an illustrative operation, UVS can be used for real-time activities such as cardholder enrolment verification, and also for reporting suspicious past activity to the relevant government agencies.

When processing telephony/voice based transaction payment processing transactions an illustrative transaction payment processing environment can operate to receive on or more telephony/voice-based requests for transaction payment processing from a cooperating telephony/voice communications network. The illustrative transaction payment processing environment can cooperate with an exemplary service bus environment having one or more telephony/voice transaction processing services/applications. The service bus environment telephony/voice transaction processing services/applications process the telephony/voice-based request to provide data responsive to the telephony/voice-based request. In turn, the illustrative transaction payment processing environment can cooperate with cooperating parties (e.g., users, merchants, banks, program sponsors, etc.) to provide the processed responsive data to the originating telephony/voice based request.

In an illustrative implementation, voice processing can be realized through a voice processing system that can comprise a set of technologies that provide an interactive voice recognition (IVR) interface to an exemplary payment transaction system. These technologies can include a VoiceXML-based dialog system, integrations with the exemplary service bus environment and interactions with modules such as FADS and UVS. In an illustrative operation, voice dialogs can be controlled by data-driven call flows that can be dynamically configurable.

Additionally, the illustrative transaction payment processing environment can further comprise a linkage engine. In this context, the linkage engine can operate to process one or more directed acyclic graphs (DAGs) to associate one or more transaction cards with one or more accounts on record for each of the transaction cards to ensure efficient and reliable transaction payment processing. In an illustrative implementation, a transaction payment processor can offer their clients the ability to have one or more transaction cards associated with one or more card accounts. For example, a transaction card could be administered such that a single transaction card is associated to two accounts (e.g., a primary account and an overflow account should the primary fail). Similarly, two transaction cards can be associated with a single account (e.g., a family share transaction card where there are multiple cards that can be used by family members but all linked to the same transaction account). It is appreciated that with volumes of users, transaction cards, and transaction accounts, the task of identifying the optimal usage of accounts is daunting. Accordingly, the linkage engine operates to optimally associate the cards and accounts according to selected criteria using DAGs.

Moreover, the illustrative transaction payment processing environment can further comprise a zero-sum accounting engine. In this context, the zero-sum accounting engine operates to analyze a set of accounts (e.g., transaction card accounts, user accounts, program accounts, and bank accounts) to ensure that the various portions of a transaction payment transaction add to zero.

In an illustrative implementation, a transaction payment processor can configure a transaction payment processing transaction to include a number of external accounts (e.g., bank accounts) and a number of internal accounts (e.g., a transaction card account, user accounts, and program accounts). The money ultimately physically resides with the bank, however, the transaction payment processor can cooperate with the banks to reconcile on a delayed basis a debit and/or credit to the physical bank account. Stated differently, a program sponsor working with a transaction payment processor may establish a loyalty pre-paid debit transaction card program such that the transaction payment processor is contracted to generate, administer, and transact 100 ten dollar pre-paid debit transaction cards for 100 consumers of the program sponsor. The transaction payment processor can cooperate with one or more banks to deposit the $1000 (100×$10/card) for the program sponsor to establish an external account, establish an internal program sponsor account indicating a value of $1000 and 100 internal user (consumer) accounts having a value of $10. When the consumers start using their cards in transactions (e.g., buying a $1 soda at the movie) the transaction payment processor operates to process such transaction. In this case, the transaction payment processor would debit the cost of the transaction (e.g., $1 soda) from the user account that is being used in the transaction. Additionally, at a later time, the transaction payment processor can operate to indicate to the bank that $1 should be debited from the program sponsor's external bank account which should be paid to the other cooperating party of the transaction (e.g., soda vendor at the movies). It is appreciated that with the numerous accounting steps and, more importantly, the latency in reconciling accounts, that zero-sum accounting becomes a Herculean task. Accordingly, the zero-sum accounting engine operates to ensure that the accounts used in a particular transaction are zero-summed.

Illustrative Computing Environment

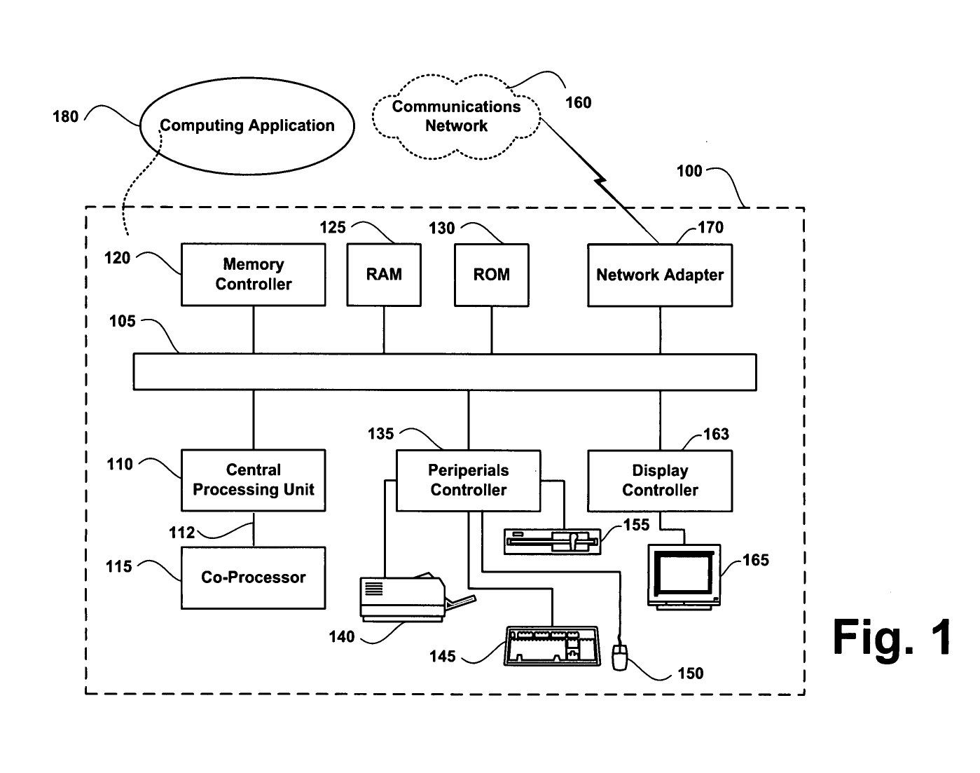

FIG. 1 depicts an exemplary computing system 100 in accordance with herein described system and methods. Computing system 100 is capable of executing a variety of computing applications 180. Exemplary computing system 100 is controlled primarily by computer readable instructions, which may be in the form of software, where and how such software is stored or accessed. Such software may be executed within central processing unit (CPU) 110 to cause data processing system 100 to do work. In many known computer servers, workstations and personal computers central processing unit 110 is implemented by micro-electronic chips CPUs called microprocessors. Coprocessor 115 is an optional processor, distinct from main CPU 110, that performs additional functions or assists CPU 110. CPU 110 may be connected to co-processor 115 through interconnect 112. One common type of coprocessor is the floating-point coprocessor, also called a numeric or math coprocessor, which is designed to perform numeric calculations faster and better than general-purpose CPU 110.

It is appreciated that although an illustrative computing environment is shown to comprise a single CPU 110 that such description is merely illustrative as computing environment 100 may comprise a number of CPUs 110. Additionally computing environment 100 may exploit the resources of remote CPUs (not shown) through communications network 160 or some other data communications means (not shown).

In operation, CPU 110 fetches, decodes, and executes instructions, and transfers information to and from other resources via the computer's main data-transfer path, system bus 105. Such a system bus connects the components in computing system 100 and defines the medium for data exchange. System bus 105 typically includes data lines for sending data, address lines for sending addresses, and control lines for sending interrupts and for operating the system bus. An example of such a system bus is the PCI (Peripheral Component Interconnect) bus. Some of today's advanced busses provide a function called bus arbitration that regulates access to the bus by extension cards, controllers, and CPU 110. Devices that attach to these busses and arbitrate to take over the bus are called bus masters. Bus master support also allows multiprocessor configurations of the busses to be created by the addition of bus master adapters containing a processor and its support chips.

Memory devices coupled to system bus 105 include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process's virtual address space unless memory sharing between the processes has been set up.

In addition, computing system 100 may contain peripherals controller 135 responsible for communicating instructions from CPU 110 to peripherals, such as, printer 140, keyboard 145, mouse 150, and data storage drive 155.

Display 165, which is controlled by display controller 163, is used to display visual output generated by computing system 100. Such visual output may include text, graphics, animated graphics, and video. Display 165 may be implemented with a CRT-based video display, an LCD-based flat-panel display, gas plasma-based flat-panel display, a touch-panel, or other display forms. Display controller 163 includes electronic components required to generate a video signal that is sent to display 165.

Further, computing system 100 may contain network adaptor 170 which may be used to connect computing system 100 to an external communication network 160. Communications network 160 may provide computer users with means of communicating and transferring software and information electronically. Additionally, communications network 160 may provide distributed processing, which involves several computers and the sharing of workloads or cooperative efforts in performing a task. It will be appreciated that the network connections shown are exemplary and other means of establishing a communications link between the computers may be used.

It is appreciated that exemplary computer system 100 is merely illustrative of a computing environment in which the herein described systems and methods may operate and does not limit the implementation of the herein described systems and methods in computing environments having differing components and configurations as the inventive concepts described herein may be implemented in various computing environments having various components and configurations.

Illustrative Networked Computing Environment:

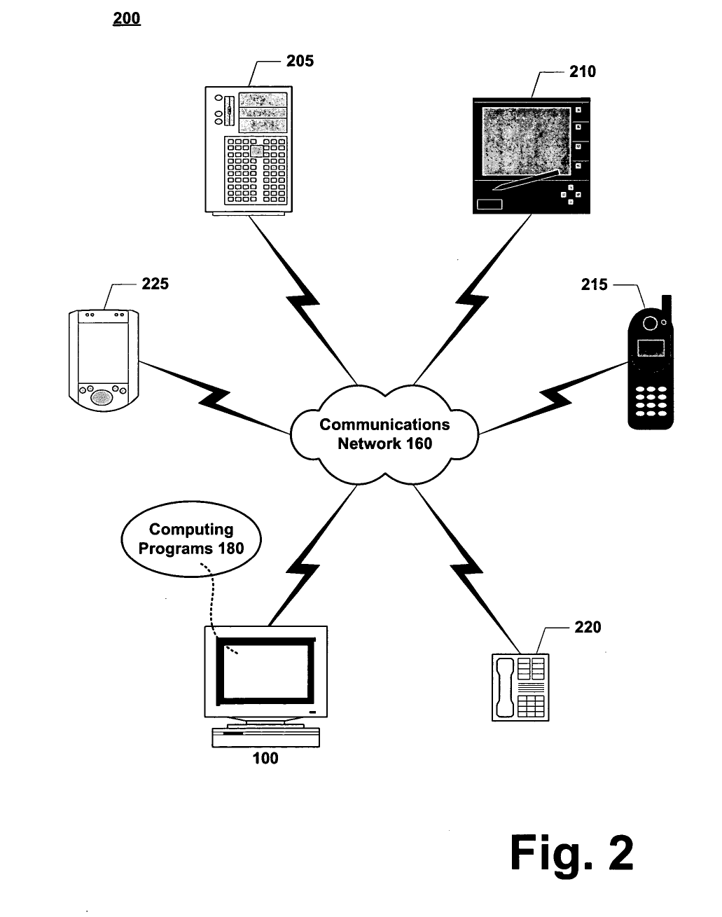

Computing system 100, described above, can be deployed as part of a computer network. In general, the above description for computing environments applies to both server computers and client computers deployed in a network environment. FIG. 2 illustrates an exemplary illustrative networked computing environment 200, with a server in communication with client computers via a communications network, in which the herein described apparatus and methods may be employed. As shown in FIG. 2 server 205 may be interconnected via a communications network 160 (which may be either of, or a combination of a fixed-wire or wireless LAN, WAN, intranet, extranet, peer-to-peer network, the Internet, or other communications network) with a number of client computing environments such as tablet personal computer 210, mobile telephone 215, telephone 220, personal computer 100, and personal digital assistance 225. In a network environment in which the communications network 160 is the Internet, for example, server 205 can be dedicated computing environment servers operable to process and communicate data to and from client computing environments 100, 210, 215, 220, and 225 via any of a number of known protocols, such as, hypertext transfer protocol (HTTP), file transfer protocol (FTP), simple object access protocol (SOAP), or wireless application protocol (WAP). Each client computing environment 100, 210, 215, 220, and 225 can be equipped with browser operating system 180 operable to support one or more computing applications such as a web browser (not shown), or a mobile desktop environment (not shown) to gain access to server computing environment 205.

In operation, a user (not shown) may interact with a computing application running on a client computing environments to obtain desired data and/or computing applications. The data and/or computing applications may be stored on server computing environment 205 and communicated to cooperating users through client computing environments 100, 210, 215, 220, and 225, over exemplary communications network 160. A participating user may request access to specific data and applications housed in whole or in part on server computing environment 205. These data may be communicated between client computing environments 100, 210, 215, 220, and 220 and server computing environments for processing and storage. Server computing environment 205 may host computing applications, processes and applets for the generation, authentication, encryption, and communication of web services and may cooperate with other server computing environments (not shown), third party service providers (not shown), network attached storage (NAS) and storage area networks (SAN) to realize such web services transactions.

Transaction Payment Processing:

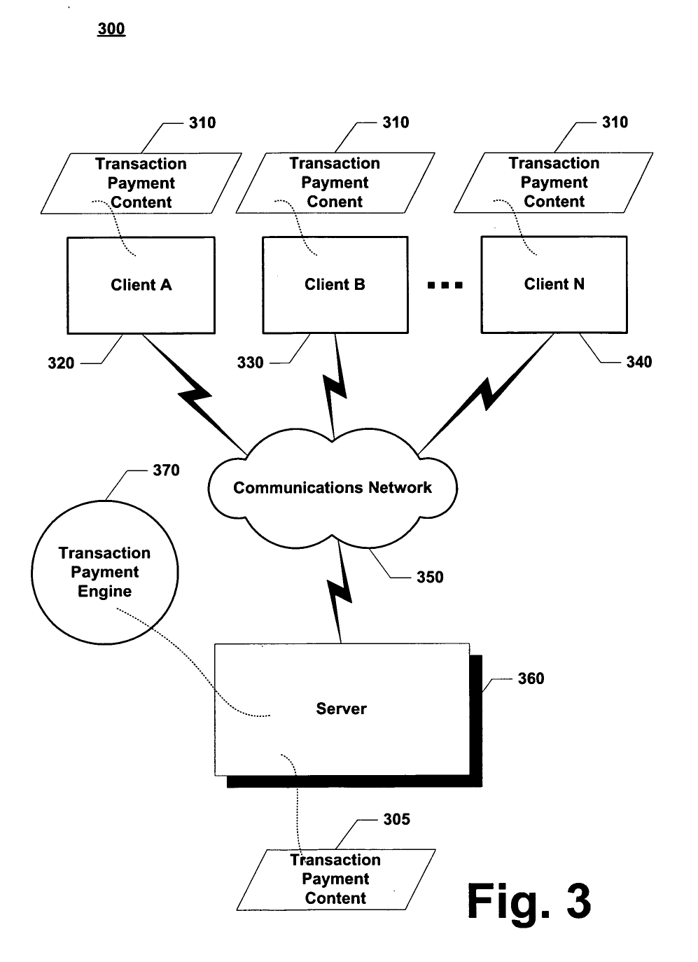

FIG. 3 is a block diagram of an illustrative transaction payment processing environment. As is shown in FIG. 3, exemplary transaction payment processing environment 300 comprises a plurality of client computing environments, Client A 320, Client B 330, up to and including Client N 340 each operable to process and display transaction payment content 310. Additionally, exemplary transaction payment processing environment 300 further comprises communications network 350 and server 360 operating transaction payment engine 370 operable to process transaction payment content 305. Transaction payment engine 370 can comprise one or more modular computing application programs operable to perform one or more portions of a transaction payment processing transaction including, but not limited to, transaction authorization, transaction fraud detection, transaction regulatory compliance processing, and voice/telephony transaction payment processing.

In operation, one or more of the plurality of clients (Client A, B, up to Client N, 320, 330, and 340, respectively) can request from or send to server 360 transaction payment content over communications network 350. In the instance data is being requested from server 360, a request is provided by one or more of clients A, B, up to N over communications network 350 to server 360. Transaction payment engine 370 processes the request for information and cooperates with the server 360 to retrieve one or more portions of transaction payment content 305. In turn, one or more portions of transaction payment content 305 is processed by transaction payment engine 370 to generate responsive data to satisfy the request for data by the one or more clients (Client A, Client B, up to Client N). The responsive data is then communicated to the requesting client(s) (A, B, up to N) over communications network 350. The responsive data can then be processed for display and navigation (or for further processing) by clients A, B, up to N as transaction payment content 310.

In an illustrative implementation, Client A can represent a cooperating bank, communications network 350 can represent a banking network (or the Internet), and transaction payment engine can represent a modular transaction payment processing platform. In operation, a bank (e.g., Client A) can request the transaction payment engine 370 to authorize a transaction. In this context, Client A sends a request for transaction authorization to transaction payment engine 370 over communications network 350. Transaction payment engine 370 can operate to process the request for transaction authorization and cooperate with the server 360 to retrieve transaction data (e.g., user account data, transaction card data, etc.) 305 for use in processing a transaction authorization. Transaction payment engine 370 can further operate, in this illustrative implementation, to generate data representative of the authorization processing and communicate the responsive data back to the bank (Client A) over communications network 350.

It is appreciated that although an illustrative transaction payment processing environment is described to have various components cooperating in various configurations that such description is merely exemplary as the inventive concepts described herein can be applied to a number of transaction payment processing environments having different components cooperating in different configurations.

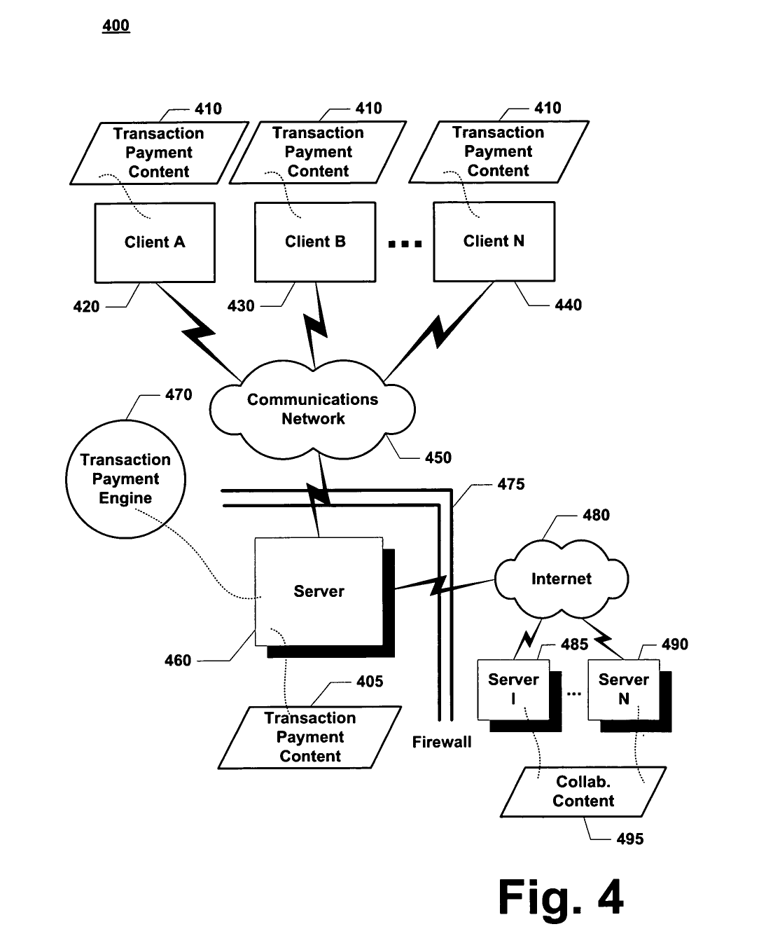

FIG. 4 is a block diagram of another illustrative implementation of an exemplary transaction payment processing environment. As is shown in FIG. 4, exemplary transaction payment processing environment 400 comprises a plurality of client computing environments, Client A 420, Client B 430, up to and including Client N 440 each operable to process and display transaction payment content 410. Additionally, exemplary transaction payment processing environment 400 further comprises communications network 450 and server 460 operating transaction payment engine 470 operable to process transaction payment content 405. Transaction payment engine 470 can comprise one or more modular computing application programs operable to perform one or more portions of a transaction payment processing transaction including, but not limited to, transaction authorization, transaction fraud detection, transaction regulatory compliance processing, and voice/telephony transaction payment processing. Additionally, as is shown, exemplary transaction payment processing environment comprises firewall 475, Internet 480, Server I 485 up to Server N 490 and collaborative content 495.

In operation, one or more of the plurality of clients (Client A, B, up to Client N, 420, 430, and 440, respectively) can request from or send to server 460 transaction payment content over communications network 450 through firewall 475. In the instance data is being requested from server 460, a request is provided by one or more of clients A, B, up to N over communications network 450, through firewall 475 to server 460. Transaction payment engine 470 processes the request for information and cooperates with the server 460 to retrieve one or more portions of transaction payment content 405. In turn, one or more portions of transaction payment content 405 is processed by transaction payment engine 470 to generate responsive data to satisfy the request for data by the one or more clients (Client A, Client B, up to Client N). The responsive data is then communicated to the requesting client(s) (A, B, up to N) over communications network 450 through firewall 475. The responsive data can then be processed for display and navigation (or for further processing) by clients A, B, up to N as transaction payment content 410.

Additionally, exemplary transaction payment processing environment 400 maintains an architecture that can be deployed as part of an enterprise environment cooperating with a third party having desired collaborative content 495. In this context, transaction payment engine 470 can communicate with a third party information provider (e.g., a bank, a transaction payment processor, a credit network, etc.) through firewall 475 and communications network 480. Responsive to a request for collaborative content 495, one or more servers (Server I up to Server N) can operate to process collaborative content 495 for communication to requesting server 460 for subsequent processing by transaction payment engine 470.

In an illustrative implementation, Client A can represent a loyalty rewards user, communications network 450 can represent the Internet, transaction payment engine can represent a modular transaction payment processing platform, Server 1 can represent a sponsor user account server (e.g., airline user account server), and collaborative content 495 can comprise user sponsor account information (user's rewards account information). In operation, a participating loyalty rewards user (e.g., Client A) can request the transaction payment engine 470 to retrieve user loyalty reward information. In this context, Client A sends a request for loyalty reward information to transaction payment engine 770 over communications network 450 through firewall 475. Transaction payment engine 470 can operate to process the request for loyalty reward information and cooperate with the server 460 to retrieve a user sponsor account information 495 from Server I 485 over the Internet 480 and through firewall 475 for use in processing loyalty reward information. Transaction payment engine 470 can further operate, in this illustrative implementation, to generate data representative of loyalty reward information and communicate the responsive data back to the bank (Client A) over communications network 450 through firewall 475.

It is appreciated that although an illustrative transaction payment processing environment is described to have various components cooperating in various configurations that such description is merely exemplary as the inventive concepts described herein can be applied to a number of transaction payment processing environments having different components cooperating in different configurations.

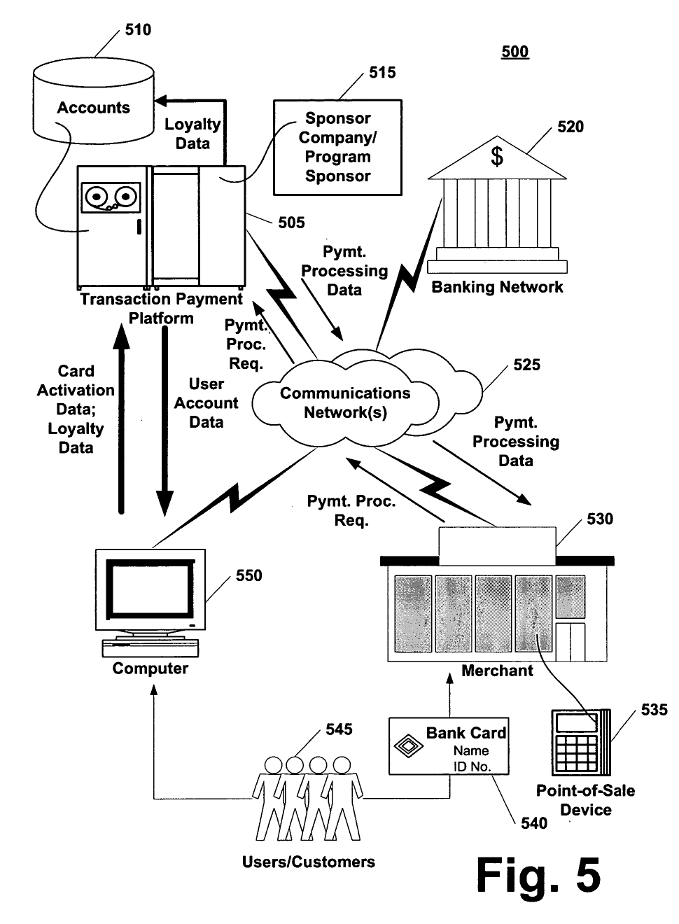

FIG. 5 shows the interaction of cooperating parties of an exemplary transaction environment 500. As is shown, in an illustrative implementation, transaction environment 500 comprises transaction payment platform 505 (operating a modular transaction payment processing environment—not shown) maintaining accounts 510, sponsor company 515, banking network 520, communications network(s) 525, merchant, 530, point-of-sale device 535, transaction card, 540, user/customers 545, and computer 550.

In an illustrative operation, a customer 545 may use a transaction card 540 to purchase goods and/or services from a merchant 530. In this context, the user 545 provides the merchant 530 with the transaction card 540 having an associated value (not shown). The merchant 530 processes the purchase by swiping the card (or entering in via the card identification information) at a point-of-sale device 535. The point-of-sale device 535, being in operable communication with the transaction payment platform 505 through communications network(s) 525 and through banking network 520, communicates a transaction payment processing request to transaction payment processing platform 505. Transaction payment processing platform 505 processes the transaction payment processing request and provides the transaction payment processing results back to POS device 535 over communications network(s) 525. Part in parcel of transaction payment processing, transaction payment processing platform 505 updates the cardholder's account and sponsor's account in account store 510 to reflect the transaction and communicates with the banking network (e.g. VISA®, MASTERCARD®, etc) 520 transaction data which may be used by the banking network 520 to reconcile possible merchant bank accounts (and/or sponsor bank accounts) to reflect the transaction. Also, as is shown, customers 545 can interact with transaction payment processing platform 505 through computer 550 that is in operable communication with transaction payment processing platform 505 through communication network(s) 525. Included in such customer interaction with transaction payment processing platform 505 can be card activation activities and account management activities.

In the context of card activation (e.g., pre-paid debit card activation, healthcare spending account card activation, gift card activation, etc.), in an illustrative implementation, transaction payment processing platform 505 operates to establish accounts for card holders and, upon the card holder receiving a the card, operating to receive card activation information from a non POS device such as computer 550. The transaction payment processing platform 505, as is described in more detail below, can operate a number of applications including online shop and earn.

In the context of online shop and earn, in an illustrative implementation, customers/users 545 may purchase goods/services at “brick and mortar” merchants 530 or online merchants (not shown) using transaction card 540. The more the card is used in such transactions the more customers/users 545 earn value to obtain an award (e.g. accrual award) that may be sponsored by sponsor company/program sponsor 515. Transaction payment processing platform 505 operates in this context to track purchases (e.g., card usage in transactions) by processing transaction data provided through customer purchases and award value (e.g., reward data) to the cardholders account (and/or sponsor accounts) stored in account store 510. The reward processing occurs exclusively on transaction payment processing platform 505 and does not receive reward data from a point of sale device (or require the POS to transmit reward data).

It is appreciated that although an illustrative transaction payment processing environment is described to have various components cooperating in various configurations that such description is merely exemplary as the inventive concepts described herein can be applied to a number of transaction payment processing environments having different components cooperating in different configurations.

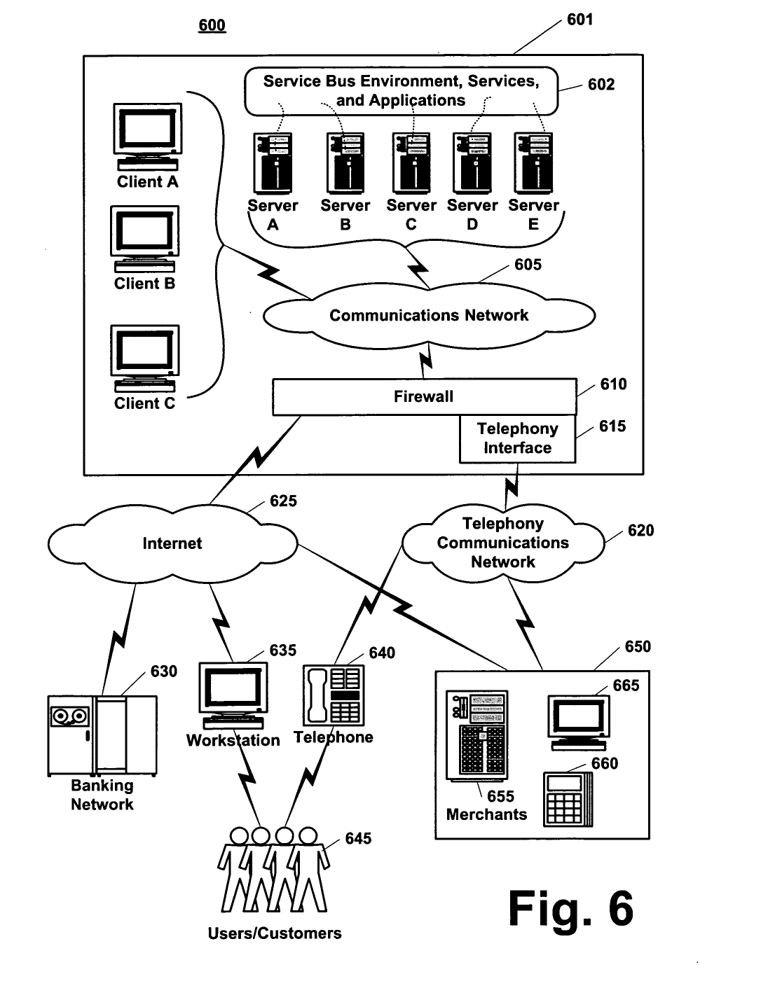

FIG. 6 shows a block diagram of exemplary transaction payment processing environment 600. As is shown in FIG. 6, exemplary transaction payment processing environment 600 comprises exemplary transaction payment processing platform 601, Internet 625, banking network 630, workstation 635, telephone 640, users/customers 645, telephony communications network 620, and merchants 650. Further as is shown in FIG. 6, transaction payment processing platform 601 comprises Clients A, b, and C, Servers A, B, C, D, and E operating service bus environment—service bus environment services and applications 602, communications network 605, firewall 610, and telephony interface 615. Additionally, as is shown in FIG. 6, merchants 650 comprise merchant server 655, point of sale devices 660, and merchant display terminal 665.

In operation, transaction payment processing platform 601 has deployed service bus environment (and service bus environment services/applications) 602 on one or more servers (e.g., Servers A, B, C, and D). The servers (e.g., Servers A, B, C, and D) are in operative communication with clients A, B, and C over communications network 605. Additionally, communications network is in operative communication with the Internet 625 through firewall 610 and with telephony communications network 620 through firewall 610 and telephony interface 615 (in no particular order). Operationally, banking network is coupled to the Internet 625, as is workstation 635 and merchants 650. Similarly, telephone 640 is operationally connected to telephony communications network 620. Last, users/customers are coupled to workstation 635 and telephone 640.

In an illustrative operation, a user 645, banking network 630, or merchant 650 can communicate to and receive from transaction payment processing platform 601 transaction payment data. In this illustrative operation, transaction payment processing platform 601 operates to receive requests to process transaction payment processing data from one ore more cooperating parties such as banking network 630, users/customers 645, and merchants 650. Responsive to a request for transaction payment processing, transaction payment processing platform 601 cooperates with service bus environment (and service bus environment services and applications) to invoke a selected service environment service/application to process data to satisfy the received request (e.g., invoke an authorization service to process a request to authorize a transaction). Transaction payment processing environment 601 can cooperate with service bus environment 602 to invoke more than one service to process received requests in parallel. Additionally, service bus environment 602 can operate a service bus environment program (not shown) which operates to perform various functions, including but not limited to, invoking services/applications, terminating services/applications, managing services/application, tracking services/applications, and load balancing services/applications to ensure optimal transaction payment processing efficiencies. Further, transaction payment processing platform 601 can operate to allow transaction payment platform operators to administer data on service bus environment 602 by navigating a user interface (not shown) on one or more clients (e.g., Client A, B, and C). When administering data on the service bus, instructions can be communicated from one or more clients (e.g., Client A, B, and C) to one or more servers (Server A, B, C, and) over communications network 605. Also, transaction payment processing platform 601 can operate to request data from cooperating parties (e.g., banking network, users, and/or merchants). In such instance transaction payment processing platform 602 can communicate with cooperating parties through communications network 605. In the case that banking network 630 is communicated to, transaction payment processing platform cooperates with banking network through communications network 605 operating through firewall 610 and Internet 625. For users/customers 645, transaction payment processing platform 601 can communicate with users/customers 645 through either the Internet 625 and firewall 610 (in no particular order) to workstation 635, or through telephony communication network 620 through firewall 610 (in no particular order) to telephone 640.

In the context of user interaction with transaction payment processing platform 601, users/customers 645 can interact with the transaction payment processing platform 601 through inputting instructions or requests for data through workstation 635. The instructions and/or requests for data are communicated from workstation 635 through Internet 625 to communications network 605 through firewall 610. The instructions and/or request for data is then processed by transaction payment processing platform 601 in the manner described previously. Additionally, as is shown, users/customers 645 can also offer instructions to and/or provide requests for data from transaction payment processing platform 601 through telephone 640. In this context, a user can provide voice commands to transaction payment processing platform 601 through telephone 640 operating on telephony communications network 620 and communicating data to transaction payment processing platform through telephony interface 615 and firewall 610 (in no particular order) to communications network 605. The voice commands can then be processed by transaction payment processing platform 601 according to the manner described previously.

Regarding merchant interaction with transaction payment processing platform 601, merchants can operate to use on or more communication instruments such as display terminal 665, merchant server 655, or point-of-sale device 660 to communicate data to and from transaction payment processing platform 601. Depending on the modality of communication, as is shown in FIG. 6, merchants 650 can communicate data to and from transaction payment processing platform 601 through Internet 625 or through telephony communication network 620. In the case where data is communicated through the Internet 625, data is communicated from the Internet 625 to communications network 605 of transaction payment processing platform 601 through firewall 610 (in no particular order). In the instance data is communicated to and from transaction payment processing platform 601 by merchants 650 through telephony communications network 620, data is communicated from telephony communications network 620 through telephony interface 615 and firewall 610 (in no particular order) to communications network 605 of transaction payment processing platform 601. Transaction payment processing platform 601 can operate to process data received from merchants 650 in a manner described previously.

Banking network 630 can interact with transaction payment processing platform 601 to communicate data for transaction payment processing. As is shown in FIG. 6, data can be communicated from banking network 630 through internet 625 through firewall 610 to communications network 605 of transaction payment processing platform 601. Transaction payment processing platform 601 can operate to process data received from banking network 630 in a manner described previously.

It is appreciated that although an illustrative transaction payment processing environment is described to have various components cooperating in various configurations that such description is merely exemplary as the inventive concepts described herein can be applied to a number of transaction payment processing environments having different components cooperating in different configurations.

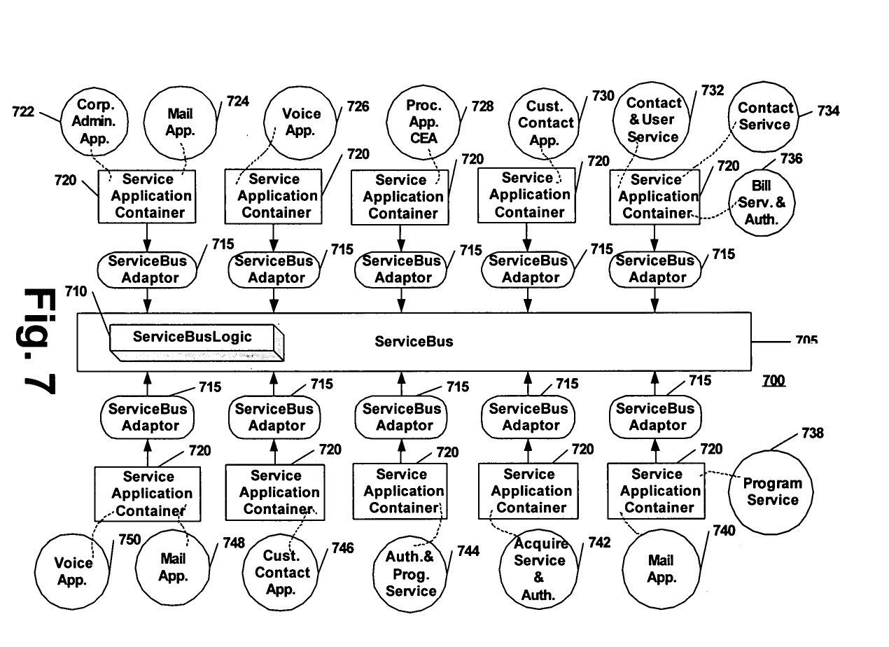

FIG. 7 is a block diagram of an illustrative service bus environment 700 for use as part of an exemplary transaction payment processing environment (e.g., 600 of FIG. 6) As is shown in FIG. 7, service bus environment 700 comprises a service bus 705 and operating service bus logic 710. The service bus environment is electronically coupled to a number of service bus adaptors 715 that are in turn communicatively coupled to one or more service application containers 720. As is shown in FIG. 7, service application containers (e.g. software applications, applets, or modules) can operate one or more services/applications that can include but are not limited to, corporate administration application 722, mail application 724, 740, and 746, voice application 726 and 750, processing application (CEA) 728, customer contact application 730 and 746, contact service—user service 732, contact service 734, bill service/authorization service 736, program service 738, processing application acquire service—authorization service 742, authentication service—program service 744.

In context to the physical deployment of exemplary service bus environment 700 and in an illustrative implementation, service bus environment 700 can be deployed across one or more computer servers accessible by one or more computer clients in a distributed client-server type computing environment architecture (as is shown in FIG. 6). The underlying hardware architecture is robust and dynamic to accommodate new application services and, in some instances, multiple of service buses. Additionally, service bus environment can be deployed as an aspect-oriented program.

In an illustrative operation, service bus environment 700 can act as a manager of operations executed by the many available services as part of transaction processing. In the illustrative operation, a transaction is sent across service bus environment 700 to one or more of available services for processing. Service bus environment 700, having knowledge of which service applications are available, routes the transaction request to one or more of the service applications to fulfill the required transaction. In addition to transaction routing, service bus environment 700 performs load balancing, and transaction reporting, logging, and tracking.

In the illustrative implementation and operation, a service application can be considered to be a computing application that is connected to service bus environment 700 via a service bus adaptor 715 (e.g., in the illustrative implementation and as is shown in FIG. 7, service bus adaptor 715 can operate to connect a service bus application to a particular version of service bus environment 700. More generally, the service bus adaptor 715 can operate as a conduit that allows the application and service bus environment 700 to communicate data back and forth). In the illustrative operation, a service application can operate to be a provider or consumer of service, or both. Examples of service applications include but are not limited to mail application 748, voice application 750, customer contact application 746, corporate administration application 722, and processing application 728. in the illustrative implementation, service bus environment 700 can operate to tie these independent applications together into a distributed system to construct a complete processing environment.

In the illustrative implementation and illustrative operation, a service can be considered to be a logically grouped set of operations; e.g., all operations dealing with accounts are grouped together as the Account Service. In the illustrative operation a service provider application can support the operations within a service and can act to provide one or more services. In the illustrative implementation, examples of services can include but are not limited to an account service, acquire service, authentication service, bill service, card service, contact service, encryption service, instant issuance service, mail service, program service, settlement transaction service, user service, voice service, and zero-accounting service.

In the illustrative implementation and illustrative operation, a service bus operation can be considered to be an indivisible unit of work. In the illustrative implementation, an operation represents an action that can take place (e.g., blocking a card), the parameters for that action (e.g., a card identifier) and the result of the action (e.g., success or failure codes). The parameters can be partially defined prior to the invocation of an operation. That is, parameters can be linked to result fields of other, yet to be executed, operations. In chaining operations, inter-application latency can be avoided when executing a stream of operations where the parameters of each operation are trivially dependent on the result of previous operations. Operation chaining can apply to operations within the same transaction.

Moreover, in the illustrative implementation, operations can be grouped into service bus environment transactions. The operations within a service bus transaction can exist as part of a different service and are executed by either a single service bus environment processor (not shown), or multiple Processors that support distributed transactions. Furthermore, in the illustrative operation, transactions can be passed to a local service adaptor 715 in their entirety. If the transaction can be executed locally, it is passed to a local service bus environment processor. However, if the transaction can not be executed locally, it is passed to a remote service bus environment processor for execution (via service bus environment 700), or split up into sub-transactions to be executed by multiple remote service bus environment processors.

A service bus environment processors (not shown) can be responsible for executing service bus environment transactions (not shown) for remote clients. In the illustrative implementation, a service application that can provide services can provide for a processor implementation. In the illustrative operation, a service bus environment processor can pass a service bus environment transaction to a local service adaptor (715) for execution. Additionally, service bus environment processors can perform inter-operation optimizations to realize processing optimizations and efficiencies.

It is appreciated that although service bus environment 700 is described in the illustrative implementation to have certain components and configurations of components, that such description is merely illustrative as the inventive concepts described herein contemplate a service bus environment having various components in various configurations. It is also appreciated that the exemplary service bus environment can be deployed in various ways above and beyond an aspect oriented program.

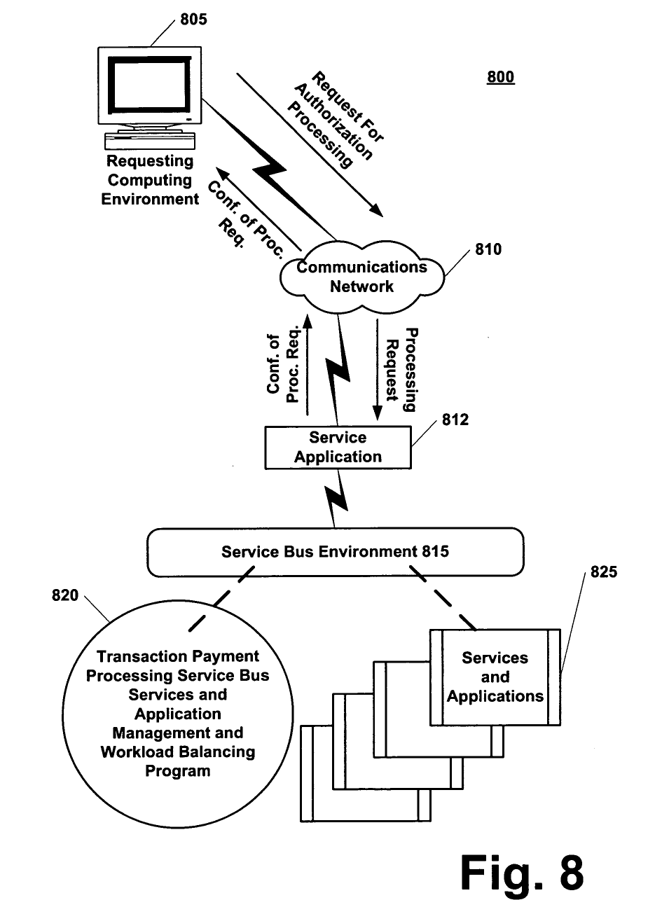

FIG. 8 shows exemplary transaction payment processing environment 800 when performing transaction authorization. As is shown in FIG. 8, exemplary transaction payment processing environment 800 comprises requesting computing environment 805 (e.g., a client computer used by a cooperating user, a banking computing environment, a merchant computing environment, or other computing environment), communications network 810, service application 812, service bus environment 815, transaction payment processing service bus services and application management and workload balancing application program 820 and services and applications 825.

In an illustrative operation, a request can be offered by requesting computing environment 805 to request authorization processing. The request can be communicated over communications network 810 to service bus environment 815 through service application 812 (e.g., processing switch application (PSA)). Service bus environment 815 can receive one or more instructions from transaction payment processing service bus services and application management and workload balancing application program 820 to select (e.g., invoke, manage, track, administer, etc.) the appropriate service bus environment service and/or application to process the authorization request. The selected service bus environment service and/or application 825 process the authorization request and provides the results of the authorization request through service bus environment 815 communicating with the requesting computing environment 805 over communications network 810.

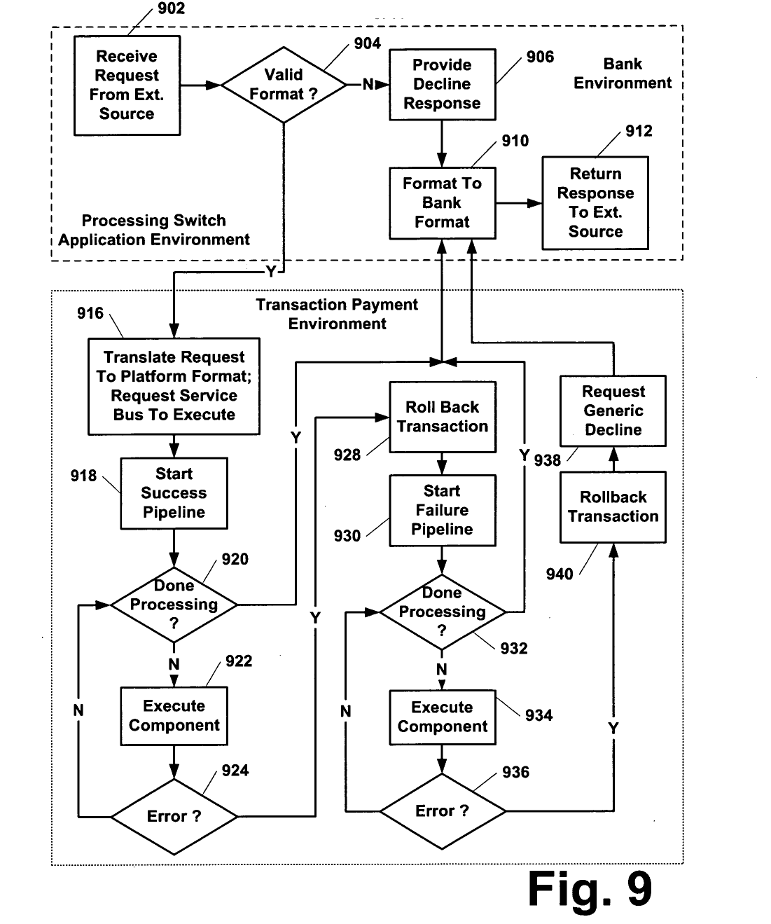

FIG. 9 is a flow diagram of the processing performed between a processing switch application and an exemplary transaction payment processing environment when performing authorization processing. As is shown, processing begins at block 902 where a request is received from an external source (e.g., a merchant). Processing the proceeds to block 904 where a check is performed to determine if the request is in a valid format. If the request is not in the valid format, processing proceeds to block 906 where a decline response is provided. From there the decline response is formatted into a payment network message format at block 910 and returned to the external source at block 912.

However, if at block 904 the check for format indicates that the received request is in the valid format, processing leaves the processing switch application environment and enters into the transaction processing payment environment (e.g., via a service bus environment). From there, processing proceeds to block 916 where a request is provided to a service bus service environment to execute the authorization request. A success pipeline is then started at block 918 and is checked to see if it completed processing at block 920. If the success pipeline is completed processing at block 920, processing proceeds to block 926 where a response to the original request is requested. From there, processing proceeds to block 910 where the request is processed according to a bank payment network message format and continues from there.

However, if at block 920 it is determined that there is additional processing to be performed, processing proceeds to block 922 where a component is executed. A check is then performed at block 924 to determine if there was an error with the component execution. If there was no error at the check of block 924, processing reverts back to block 920 and proceeds from there. However, if the check at block 924 indicates that there is an error, processing proceeds to block 928 where the transaction is rolled back. From there, processing proceeds to block 930 where a failure pipeline is started. A check is then performed at block 932 to determine if the processing is completed. If the processing for the failure pipeline has been completed, processing proceeds to block 926 and proceeds from there. However, if the check at block 932 indicates that processing has not been completed for the failure pipeline, processing proceeds to block 934 where a component is executed. A check is then performed at block 936 to determine if there was an error with in the execution of the component. If there was no error at block 936, processing reverts to block 932 and continues from there.

However if at block 936, it is determine that there was an error during the execution of a component of the failure pipeline, processing proceeds to block 940 where the transaction is rolled back. From there processing proceeds to block 938 where a generic decline is requested. Processing then proceeds to block 910 and continues from there.

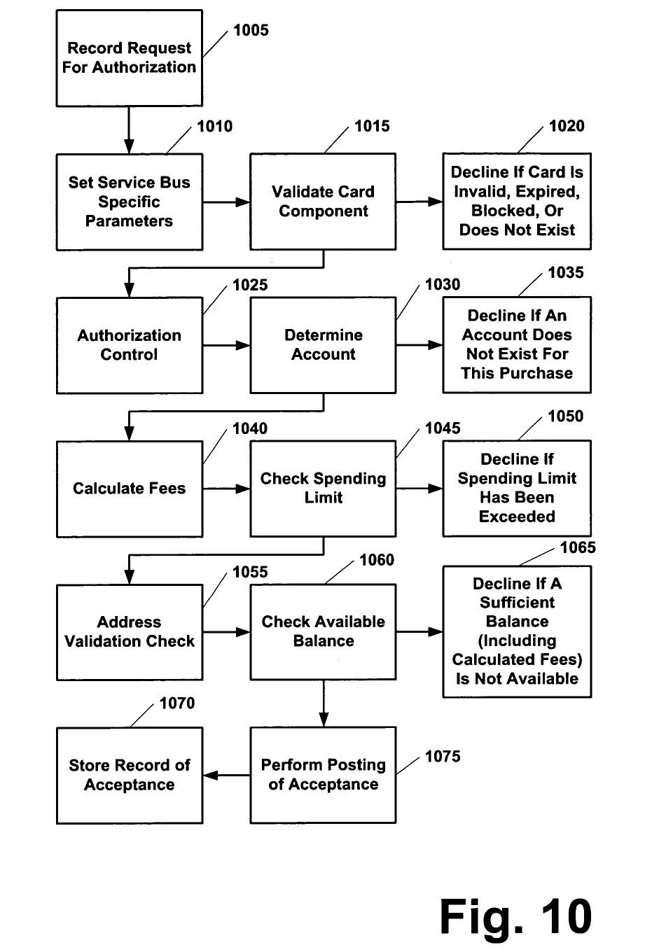

FIG. 10 is a flow diagram of the processing performed when performing transaction authorization by an exemplary transaction payment processing environment (e.g., 600 of FIG. 6). As is shown in FIG. 10, processing begins at block 1005 where a request for authorization is recorded. From there processing proceeds to block 1010 where service bus environment specific parameters are set. From there, the card component is validated at block 1015. The card is declined at block 1020 if the car is invalid, expired, blocked or does not exist. Otherwise, processing proceeds from block 1015 to block 1025 where authorization control is performed. From there processing proceeds to block 1030 where the account is determined. The account is declined if the account does not exist for the transaction being processed for authorization at block 1035. Otherwise, processing proceeds to block 1040 where the fees for the transaction are calculated. A check is then performed at block 1045 to determine the spending limit on the card. The card is declined (e.g., authorization denied) if the spending limit has been exceeded at block 1050. Otherwise, processing proceeds to block 1055 where an address validation check is performed (e.g., determine the geographic location of the transaction and compare against a selected authorization criteria). From there, processing proceeds to block 1060 where the available balance on the account(s) associated with the card is ascertained. The card is declined at block 1065 if there is an insufficient balance (including calculated fees). Otherwise, processing proceeds to block 1075 where perform positing of acceptance and a record of the acceptance is stored at block 1070.

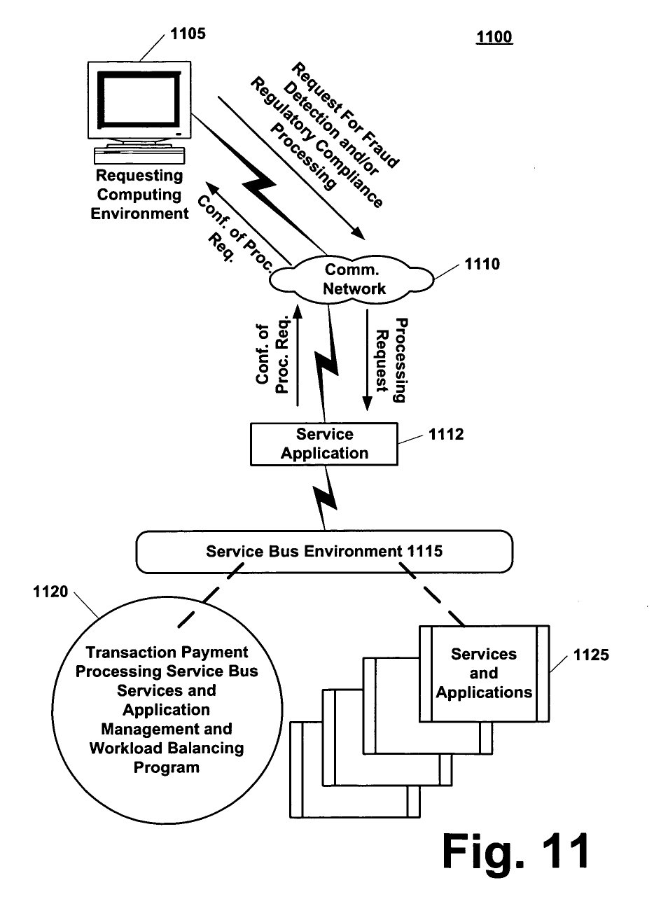

FIG. 11 shows exemplary transaction payment processing environment 1100 when performing fraud detection and/or regulatory compliance operations surrounding transaction payment processing transactions. As is shown in FIG. 11, exemplary transaction payment processing environment 1100 comprises requesting computing environment 1105 (e.g., a client computer used by a cooperating user, a banking computing environment, a merchant computing environment, or other computing environment), communications network 1110, service bus environment 1115, transaction payment processing service bus services and application management and workload balancing application program 1120 and services and applications 1125.

In an illustrative operation, a request can be offered by requesting computing environment 1105 to request fraud detection and/or regulatory compliance processing. The request can be communicated over communications network 1110 to service bus environment 1115. Service bus environment 1115 can receive one or more instructions from transaction payment processing service bus services and application management and workload balancing application program 1120 to select (e.g., invoke, manage, track, administer, etc.) the appropriate service bus environment service and/or application to process the fraud detection and/or regulatory compliance request. The selected service bus environment service and/or application 1125 process the fraud detection and/or regulatory compliance request and provides the results of the fraud detection and/or regulatory compliance request through service bus environment 1115 communicating with the requesting computing environment 1105 over communications network 1110.

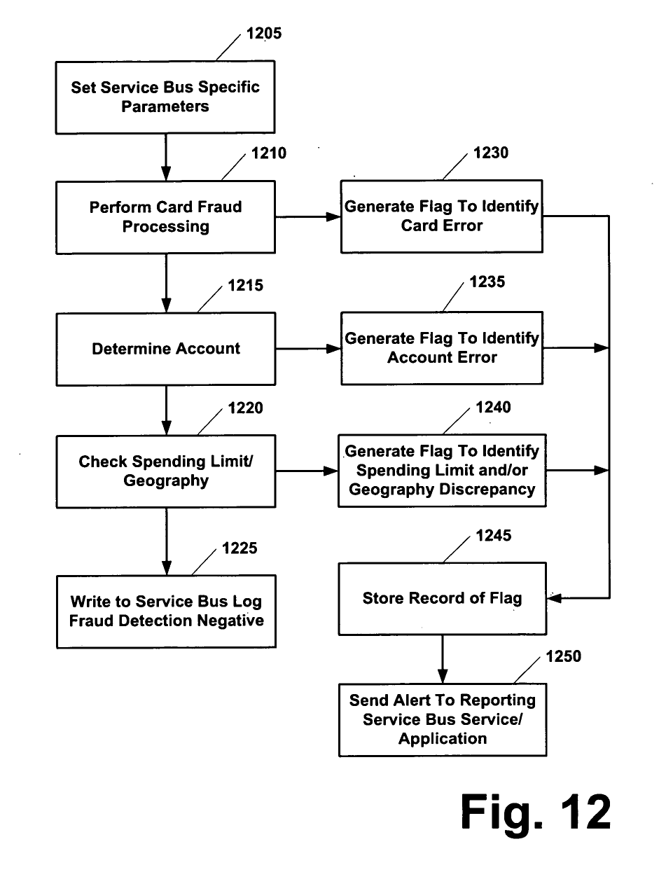

FIG. 12 shows the processing performed when processing fraud detection by an exemplary transaction payment processing environment (e.g., 600 of FIG. 6). As is shown, processing begins at block 1205 where the service bus specific parameters are set. From there card fraud processing is performed at block 1210. Processing then proceeds to either of blocks 1215 if the card fraud detection is negative and to block 1230 if the card fraud detection failed. If the card fraud detection is positive, processing proceeds to block 1230 where an error is generate to identify that there is an error in the card. From block 1230 processing proceeds to block 1245 were a record of the flag is stored. An alert is then sent to a service bus reporting service/application at block 1250.

If however, the card fraud check is negative at block 1210, processing proceeds to block 1215 where an account is determined. If an account cannot be determined at block 1215, processing goes to block 1235 where a flag is generated to identify the account error. From block 1235, processing proceeds to block 1245 and proceeds from there. Once the account is determined, processing moves to block 1220 where the account spending limit and geography of the card is checked. If the spending limit is exceeded and/or the geographic check is faulty, processing proceeds to block 1240 where a flag is generated to identify that the spending limit has been exceeded and/or there is a geographic discrepancy for the card transaction. Processing then continues to block 1245 and proceeds from there. If the spending limit has not been exceeded and the results of the geographic check are negative, processing proceeds to block 1250 where an alert is sent to a reporting service bus service/application.

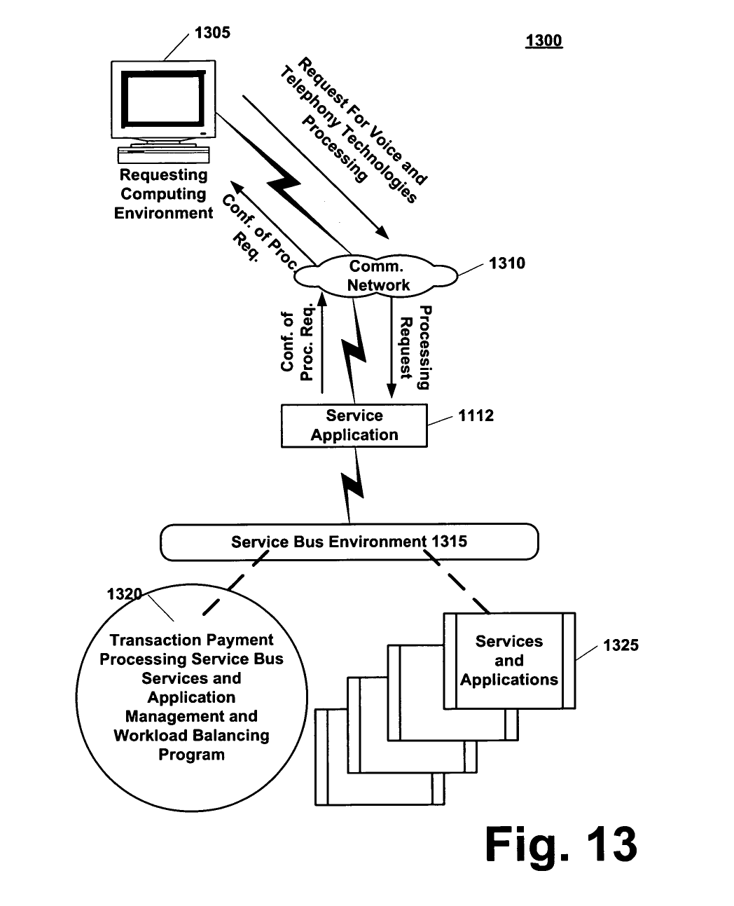

FIG. 13 shows exemplary transaction payment processing environment 1300 when performing voice and telephony technologies processing surrounding transaction payment processing operations. As is shown in FIG. 13, exemplary transaction payment processing environment 1300 comprises requesting computing environment 1305 (e.g., a client computer used by a cooperating user, a banking computing environment, a merchant computing environment, or other computing environment), communications network 1310, service bus environment 1315, transaction payment processing service bus services and application management and workload balancing application program 1120 and services and applications 1325.

In an illustrative operation, a request can be offered by requesting computing environment 1305 to request voice and telephony technologies processing. The request can be communicated over communications network 1310 to service bus environment 1315. Service bus environment 1315 can receive one or more instructions from transaction payment processing service bus services and application management and workload balancing application program 1320 to select (e.g., invoke, manage, track, administer, etc.) the appropriate service bus environment service and/or application to process the voice and telephony technologies request. The selected service bus environment service and/or application 1325 process the voice and telephony technologies processing request and provides the results of the voice and telephony technologies processing request through service bus environment 1315 communicating with the requesting computing environment 1305 over communications network 1310.

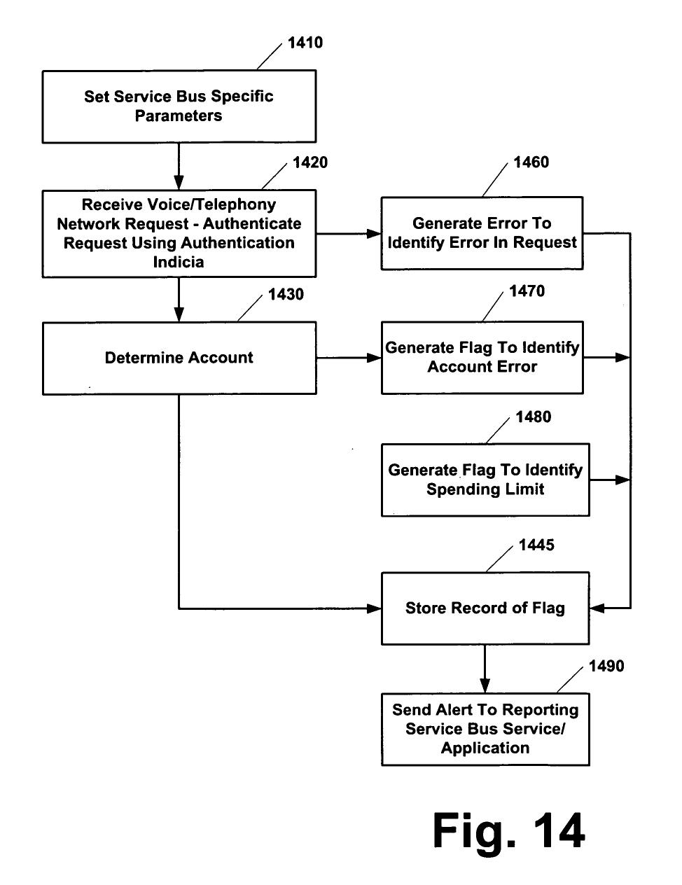

FIG. 14 shows the processing performed when processing voice/telephony requests by an exemplary transaction payment processing environment (e.g., 600 of FIG. 6). As is shown, processing begins at block 1410 where the service bus specific parameters are set. From there a request for voice/telephony is received and authenticated at block 1420. Processing then proceeds to either of blocks 1430 if the authentication passed and to block 1460 if the authentication failed. If the authentication failed, processing proceeds to block 1460 where an error is generate to identify that there is an error in the request. From block 1460 processing proceeds to block 1445 were a record of the flag is stored. An alert is then sent to a service bus reporting service/application at block 1490.

If however, the request is properly authenticated at block 1420, processing proceeds to block 1430 where an account is determined. If an account cannot be determined at block 1430, processing goes to block 1470 where a flag is generated to identify the account error. From block 1470, processing proceeds to block 1445 and proceeds from there. Once the account is determined, processing proceeds to block 1445 and proceeds from there.

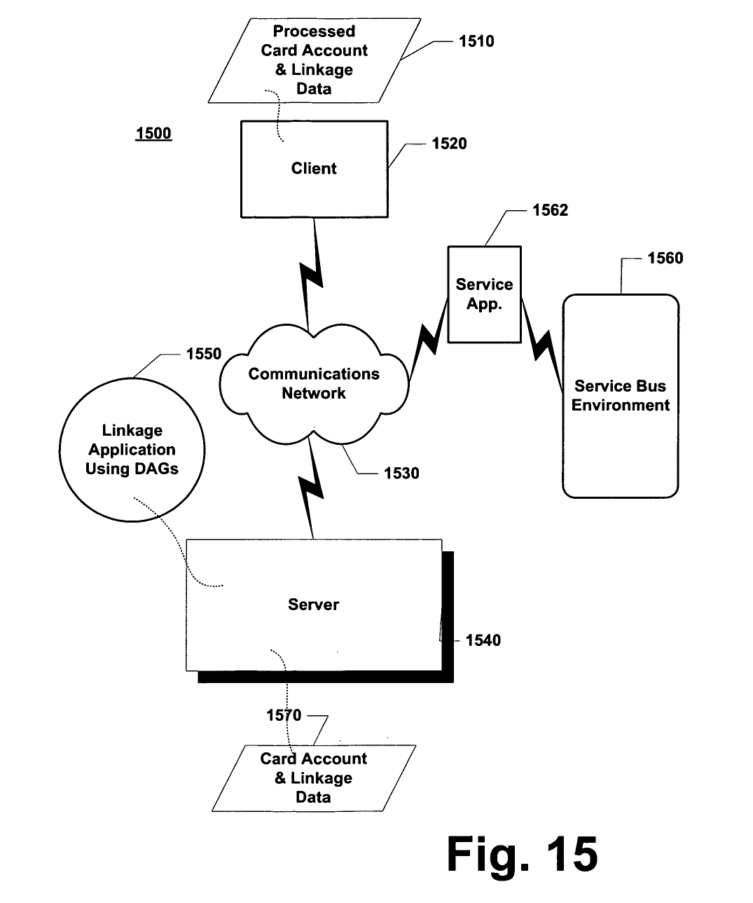

FIG. 15 shows exemplary transaction payment processing environment 1500 when performing transaction card and account linkage operations surrounding transaction payment processing transactions using directed acyclic graphs (DAGs). As is shown in FIG. 15, exemplary transaction payment processing environment 1500 comprises client 1520 (e.g., a client computer used by a cooperating user, a banking computing environment, a merchant computing environment, or other computing environment), communications network 1530, service bus environment 1560, server 1540, processed card account and linkage data 1510, card account and linkage data 1570, and linkage application using DAGs 1550.

In an illustrative operation, a request can be offered by client computing environment 1520 to request the processing of transaction card and account linkage processing. The request can be communicated over communications network 1530 to server 1540. Server 1540 can cooperate with linkage application 1550 and service bus environment 1560 to process card account and linkage data 1570 to generate processed card account and linkage data 1510. In the illustrative implementation, server 1540 cooperating with linkage application using DAGs 1550 can retrieve various account and card information from a cooperating data store (not shown) to generate associations and linkages between transaction cards and accounts (not shown). The generated linkages and associations can comprise a portion or the whole of processed card account and linkage data 1510. Furthermore, processed card account and linkage data 1510 can be communicated by server 1540 over communications network 1530 to client for further processing, display, and/or navigation.

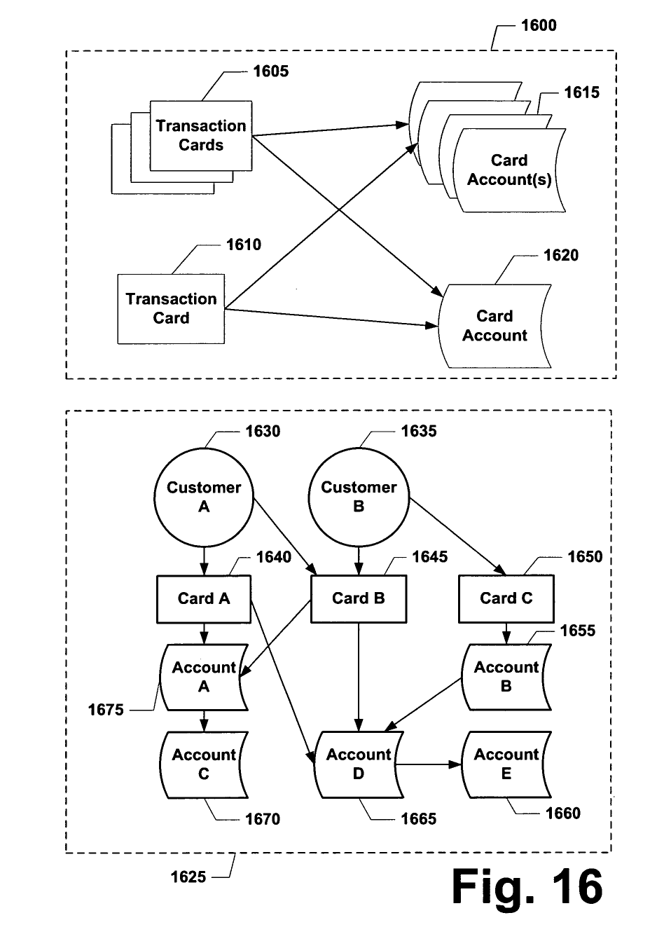

FIG. 16 shows a block diagram of exemplary directed acyclic graphs (DAGs) 1600 and 1625. As is shown in FIG. 16, exemplary DAG 1600 comprises a plurality of transaction cards 1605, transaction card 1610, a plurality of transaction card accounts 1615 and card account 1620. As is further shown in FIG. 16 by the arrowed lines, the relationships in DAG 1600 can include a plurality of transaction cards 1605 to a plurality of card accounts 1615, a plurality of transaction cards 1605 to a single card account 1620, a single transaction card 1610 to a plurality of card accounts 115, and a single transaction card 1610 to a single card account 1620.

Similarly DAG 1615 describes relationships between various transaction cards, accounts, and customers. As is shown in FIG. 16, DAG 1625 comprises Customer A 1630, Customer B 1635, Card A 1640, Card B 1645, Card C 1650, Account A 1675, Account B 1655, Account C 1670, Account D 1665, and Account E 1660. As the arrowed lines indicate, the relationships in DAG 1625 can include Customer A to Card A to Account A to Account C, Customer A to Card B to Account D to Account E, Customer A to Card B to Account A to Account C, Customer B to Card B to Account A to Account C, Customer B to Card B to Account D to Account E, and Customer B to Card C to Account B to Account D to Account E.

In an illustrative operation the herein described systems and methods can employ DAG 1600 or DAG 1625 as part of optimization processing to identify which transaction card and which card account to employ when performing a particular transaction payment processing transaction. DAGs 1600 and 1625 can also be used to define parameters for the selection of transaction cards and accounts when performing transaction payment processing.

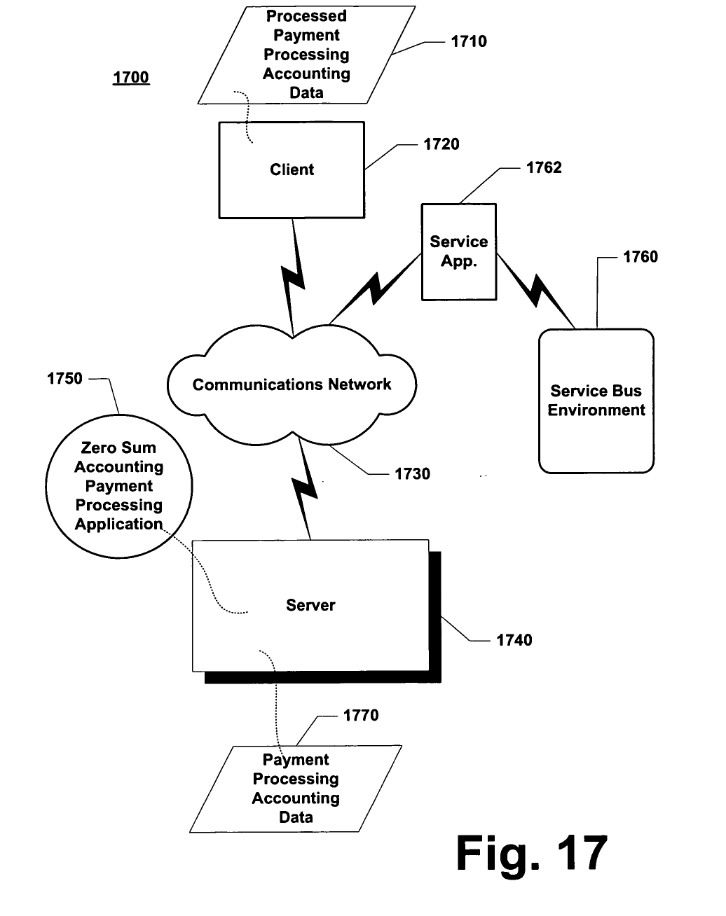

FIG. 17 shows exemplary transaction payment processing environment 1700 when performing zero-sum accounting operations surrounding transaction payment processing transactions. As is shown in FIG. 17, exemplary transaction payment processing environment 1700 comprises client 1720 (e.g., a client computer used by a cooperating user, a banking computing environment, a merchant computing environment, or other computing environment), communications network 1730, service bus environment 1760, server 1740, payment processing accounting data 1770, processed payment processing accounting data 1710, and zero-sum accounting payment processing application 1750.

In an illustrative operation, a request can be offered by client computing environment 1720 to request the processing of zero-sum accounting for payment processing transactions. The request can be communicated over communications network 1730 to server 1740. Server 1740 can cooperate with zero-sum accounting payment processing application 1750 and service bus environment 1760 to process payment processing accounting data 1770 to generate processed payment processing accounting data 1710. In the illustrative implementation, server 1740 cooperating with zero-sum accounting payment processing application 1750 can retrieve various account, card, and transaction information from a cooperating data store (not shown) to generate a zero-sum accounting of payment processing transactions (not shown). The zero-sum accounting of payment processing transactions can comprise a portion or the whole of processed payment processing accounting data 1710. Furthermore, processed payment processing accounting data 1710 can be communicated by server 1740 over communications network 1730 to client for further processing, display, and/or navigation.

Thus, the systems and methods described herein can be utilized in a computer network environment having client computing environments for accessing and interacting with the network and server computing environments for interacting with client computing environment. However, the apparatus and methods providing the data caching architecture can be implemented with a variety of network-based architectures, and thus should not be limited to the example shown. The herein described systems and methods will now be described in more detail with reference to a presently illustrative implementation.

In sum, the herein described apparatus and methods provide a data communication architecture employing for use as a computing environments communication fabric that reduces data latency. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wireless and wireless computer environments), partial computing environments, and real world environments. The various techniques described herein may be implemented in hardware or software, or a combination of both. Preferably, the techniques are implemented in computing environments maintaining programmable computers that include a processor, a storage medium readable by the processor (including volatile and non-volatile memory and/or storage elements), at least one input device, and at least one output device. Computing hardware logic cooperating with various instructions sets are applied to data to perform the functions described above and to generate output information. The output information is applied to one or more output devices. Programs used by the exemplary computing hardware may be preferably implemented in various programming languages, including high level procedural or object oriented programming language to communicate with a computer system. Illustratively the herein described apparatus and methods may be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The apparatus may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed is:

1. A transaction processing system comprising:
a service bus environment operable to process transaction processing data from one or more cooperating transaction processing modules,
wherein the service bus environment is a data driven environment; and
a service bus environment computing program operable to provide one or more instructions to the service bus environment to process transaction processing data.

2. The system as recited in claim 1 further comprising a service bus adaptor operable in the service bus environment to communicate data between service bus environment components.

3. The system as recited in claim 2 further comprising a service application container operable with the service bus adaptor to provide access to one or more service bus applications and/or services.

4. The system as recited in claim 3 further comprising a service bus application operable to perform one or more functions representative of transaction payment processing.

5. The system as recited in claim 4 further comprising service bus services operable to perform one or more functions representative of transaction payment processing.

6. The system as recited in claim 5 further wherein the service bus environment computing program operates to perform one or more functions comprising any of initiating a service bus service, managing a service bus application, managing a service bus service, performing workload balancing between cooperating service bus applications and/or service bus services, tasking a service bus application, tasking a service bus service, tracking a service bus application, tracking a service bus service, terminating a service bus application, and terminating a service bus service.

7. The system as recited in claim 6 wherein the service bus environment comprises a computing environment.

8. The system as recited in claim 7 wherein the service bus environment comprises a distributed computing environment.

9. The system as recited in claim 8 further comprising a communications network operable to communicate data between components of the service bus environment.

10. The system as recited in claim 9 further comprising a communications network operable to communicate data between the service bus environment and other communication networks external to the service bus environment.

11. The system as recited in claim 10 wherein further comprising a web services interface allowing communication of data between service bus environment components and/or other external communications networks using a web services communication architecture.

12. The system as recited in claim 1 wherein the service bus environment is operable to perform processing representative of transaction payment authentication and authorization.

13. The system as recited in claim 1 wherein the service bus environment is operable to perform processing representative of fraud detection functions associated with transaction payments.

14. The system as recited in claim 1 wherein the service bus environment is operable to perform processing representative of regulatory compliance functions associated with transaction payments.

15. The system as recited in claim 1 wherein the service bus environment is operable to perform processing representative of transaction payment through voice and/or telephony networks.

16. The system as recited in claim 1 wherein the service bus environment is operable to perform processing representative of a hierarchical zero-sum transaction payment processing.

17. The system as recited in claim 1 wherein the service bus environment is operable to perform processing representative of linking transaction cards with transaction accounts using directed acyclic graphs.

18. The system as recited in claim 1 wherein the service bus environment comprises a modular computing application architecture that is scalable and upgradeable on a module by module basis.

19. The system as recited in claim 18 wherein the service bus environment computing program is operable in a computing environment.

20. The system as recited in claim 19 wherein the service bus environment computing program is operable in a distributed computing environment.

21. The system as recited in claim 20 wherein the service bus environment is a data driven computing environment operable to perform processing through the use of a service bus service and/or service bus application upon the identification of selected data.

22. A method for transaction payment processing comprising:
receiving a request for transaction payment processing by a transaction payment processing platform; and
initiating at least one of a service and an application on a cooperating service bus environment to handle one or processes representative of transaction payment processing,
wherein the service bus environment is operable to process transaction processing data from one or more cooperating transaction processing modules,
wherein the service bus environment is a data driven environment.

23. The method as recited in claim 22 further comprising executing the at least one of a service and application on the service bus environment.

24. The method as recited in claim 23 further comprising initiating a service bus environment program providing one or more instructions to the service bus environment to process transaction payment data.

25. The method as recited in claim 24 further comprising managing the at least one of a service and application by the service bus environment program.

26. The method as recited in claim 25 further comprising authenticating the transaction according to one or more selected protocols comprising any of: transaction authorization, fraud detection, and regulatory compliance protocols.

27. The method as recited in claim 26 further comprising providing the one or more selected protocols as any of a service bus environment service and a service bus environment application.

28. The method as recited in claim 26 further comprising providing a communications network for communication of data and instructions between components of the service bus environment.

29. The method as recited in claim 28 further comprising providing a communications network for communication of data between the service bus environment and other communications networks.

30. The method as recited in claim 29 further comprising processing voice and/or telephony network data by the service bus environment as part of a transaction payment processing.

31. The method as recited in claim 29 further comprising providing processed transaction payment data to requesting parties.

32. The method as recited in claim 22 further comprising initiating a selected service bus environment service and/or service bus environment application responsive to a request for a selected transaction payment processing.

33. The method as recited in claim 32 further comprising selecting the service bus environment service and/or service bus environment application by a cooperating service bus environment program.

34. The method as recited in claim 33 further comprising managing the service bus environment service and/or service bus environment application by the cooperating service bus environment program.

35. The method as recited in claim 34 further comprising performing load balancing for initiated service bus environment services and/or service bus environment applications by the service bus environment program.

36. The method as recited in claim 35 further comprising terminating one or more service bus environment services and/or service bus applications by the service bus environment program.

37. The method as recited in claim 25 further comprising communicating with one or more transaction payment system parties comprising any of a customer, merchant, sponsor, program coordinator, and banking network to provide processed transaction payment data.

38. The method as recited in claim 37 further comprising providing at least one user interface operable to cooperate with the service bus environment to communicate data for transaction payment processing.

39. The method as recited in claim 38 further comprising providing at least one user interface operable to cooperate with the service bus environment to retrieve processed transaction payment processing.

40. The method as recited in claim 39 further comprising updating at least one service bus service and/or service bus application responsive to a change in one or parameters in transaction payment processing.

41. The method as recited in claim 22 further comprising providing data driven service bus environment services and/or service bus environment applications.

42. The method as recited in claim 40 further comprising providing the service bus environment as an aspect oriented program.

43. The method as recited in claim 40 further comprising providing one or more program modules to process transaction payment processing data.

44. The method as recited in claim 43 further comprising providing one or more program modules to execute one or more transaction payment processing functions.

45. The method as recited in claim 43 further comprising providing an interceptor operatively cooperating with the one or more program modules that operates to change one or more functions of the one or more program modules.

46. The method as recited in claim 45 further comprising changing the function of the interceptor to modify one or more steps in a transaction payment process.

47. A computer readable medium having instructions to instruct a computer to perform the method comprising:
receiving a request for transaction payment processing by a transaction payment processing platform; and
initiating at least one of a service and an application on a cooperating service bus environment to handle one or processes representative of transaction payment processing.

48. A computer readable medium having computer readable instructions to instruct a computer to perform transaction payment processing comprising:
receiving a request to perform one or more transaction payment processes; and
initiating a service and/or application operable on a service bus environment operable to perform in whole or in part the one or more transaction payment processes,
wherein the service bus environment is operable to process transaction processing data from one or more cooperating transaction processing modules,
wherein the service bus environment is a data driven environment.

49. The computer readable medium as recited in claim 48 further comprising managing the service and/or application by a service bus environment program.

50. The computer readable medium as recited in claim 49 further comprising performing a transaction payment process comprising any of: payment authorization, fraud detection, regulatory compliance, and payment reconciliation.

51. The computer readable medium as recited in claim 50 further comprising performing a zero-sum accounting of transacted payments.

52. The computer readable medium as recited in claim 50 further comprising processing transaction payment data for communication over a telephony/voice communications network.

53. The computer readable medium as recited in claim 52 further comprising receiving transaction payment processing requests over a telephony/voice communications network.

54. The computer readable medium as recited in claim 53 further comprising translating transaction payment processing data using selected voice XML web pages operable of a web server.

55. A system for performing authorization processing for a transaction payment comprising:
a service bus environment having one or more service bus environment services and/or service bus environment applications operable to perform authorization processing,
wherein the service bus environment is operable to process transaction processing authorization data from one or more cooperating authorization processing modules; and
a service bus environment program cooperating with the service bus environment providing instructions to the service bus environment to process transaction payment authorization data.

56. The system as recited in claim 55 wherein the service bus environment comprises a computing environment.

57. The system as recited in claim 56 wherein the service bus environment comprises a distributed computing environment.

58. The system as recited in claim 55 wherein the service bus environment is a data driven computing application.

59. The system as recited in claim 58 wherein the service bus environment performs a management function comprising any of: changing of a selected transaction payment system authorization processing module, the addition of a service bus environment service and/or a service bus environment application, the reconfiguration of a service bus environment service and/or service bus environment application, and the bypassing of a service bus environment service and/or service bus environment application.

60. The system as recited in claim 59 further comprising a user interface providing access to the service bus environment to perform one or more of the management functions.

61. The system as recited in claim 59 further wherein the management functions are managed by a service bus environment program.

62. A method for performing transaction payment authorization comprising:
receiving a request for transaction payment authorization processing from a cooperating transaction payment processing system component;
validating data of the transaction payment authorization request; and
responsive to the validation of the transaction payment authorization request data initiating at least one service bus environment service and/or application to perform transaction payment authorization processing,
wherein the service bus environment is operable to process transaction processing authorization data from one or more cooperating authorization processing modules.

63. The method as recited in claim 62 further comprising formatting the transaction payment authorization request data into a data format that can be processed by the service bus environment.

64. The method as recited in claim 63 further comprising communicating the transaction payment authorization request data to the at least one service bus environment service and/or application via a service bus environment communications network.

65. The method as recited in claim 64 further comprising approving the transaction payment transaction.

66. The method as recited in claim 64 further comprising declining the transaction payment transaction based on the transaction payment transaction failing one or more selected transaction payment authorization tests.

67. The method as recited in claim 64 further comprising communicating the results of the transaction payment authorization processing to cooperating parties comprising any of financial bank networks, customers, and program sponsors through a communications network.

68. The method as recited in claim 67 further comprising tracking at least one transaction payment authorization processing event by a service bus environment service and/or application.

69. The method as recited in claim 68 further comprising storing transaction payment authorization processing formatted data by a service bus environment service and/or application for subsequent processing.

70. The method as recited in claim 69 further comprising reporting transaction payment authorization processing data by a service bus environment service and/or application to cooperating parties comprising any of a bank, a customer, and a program sponsor.

71. A computer readable medium having compute readable instructions to instruct a computing environment to perform a method comprising:
receiving a request for transaction payment authorization processing from a cooperating transaction payment processing system component;
validating data of the transaction payment authorization request; and
responsive to the validation of the transaction payment authorization request data initiating at least one service bus environment service and/or application to perform transaction payment authorization processing.

72. In a modular transaction payment processing system having a service bus environment operable to initiate, manage, and control at least one service bus environment service and/or service bus environment application, a system for transaction payment authorization comprising:
a service bus service/application container operable to house a service bus environment service and/or service bus environment application;
a service bus adaptor operable to operatively link a service bus environment service and/or application to a service bus environment service bus; and
a transaction payment authorization service bus service/application operable to receive transaction payment data and perform transaction payment authorization processing according to one or more selected transaction payment authorization processing protocols.

73. The system as recited in claim 72 further comprising a service bus environment program operable to provide one or more instructions to the service bus environment to communicate data between cooperating components of the service bus environment.

74. The system as recited in claim 73 wherein the service bus environment initiates a service to perform an approval protocol for a transaction payment being processed for transaction payment authorization.

75. The system as recited in claim 74 wherein the service bus environment initiates a the service/application to perform a decline protocol for a transaction payment being processed for transaction payment authorization.

76. A system for detecting fraud for a transaction payment comprising:
a service bus environment having one or more service bus environment services and/or service bus environment applications operable to perform fraud processing; and
a service bus environment program cooperating with the service bus environment providing instructions to the service bus environment to process transaction payment fraud data,
wherein the service bus environment is operable to process transaction processing fraud detection data from one or more cooperating fraud detection processing modules.

77. The system as recited in claim 76 wherein the service bus environment comprises a computing environment.

78. The system as recited in claim 77 wherein the service bus environment comprises a distributed computing environment.

79. The system as recited in claim 78 wherein the service bus environment is a data driven computing application.

80. The system as recited in claim 79 wherein the service bus environment performs at least one fraud detection for transaction payments function comprising any of: validating transaction card information, checking account balances, checking geography of transactions, and comparing against account limits.

81. The system as recited in claim 80 further comprising a user interface providing access to the service bus environment to perform the at least one of a fraud detection function.

82. The system as recited in claim 81 further wherein the at least one of a fraud detection function is performed by a service bus environment program.

83. A method for detecting fraud for a transaction payment comprising:
receiving data representative of one or more transaction payments from a cooperating transaction payment processing system component;
validating the transaction payment data according to one or more selected fraud detection protocols; and
responsive to the validation of the transaction payment data initiating at least one service bus environment service and/or application to perform fraud detection,
wherein the service bus environment is operable to process transaction processing fraud detection data from one or more cooperating fraud detection processing modules.

84. The method as recited in claim 83 further comprising formatting the transaction payment data into a data format that can be processed by the service bus environment.

85. The method as recited in claim 84 further comprising communicating the transaction payment data to the at least one service bus environment service and/or application via a service bus environment communications network.

86. The method as recited in claim 85 further comprising approving the transaction payment transaction based on passing at least one selected fraud detection protocol.

87. The method as recited in claim 85 further comprising declining the transaction payment transaction based on the transaction payment transaction failing one or more selected fraud detection protocols.

88. The method as recited in claim 85 further comprising communicating the results of the transaction payment fraud detection to cooperating parties comprising any of bank networks, customers, and program sponsors through a communications network.

89. The method as recited in claim 88 further comprising tracking at least one transaction payment fraud detection event by a service bus environment service and/or application.

90. The method as recited in claim 89 further comprising storing transaction payment fraud detection data by a service bus environment service and/or application for subsequent processing.

91. The method as recited in claim 90 further comprising reporting transaction fraud detection formatted data by a service bus environment service and/or application to cooperating parties comprising any of a bank, a customer, and a program sponsor.

92. A computer readable medium having compute readable instructions to instruct a computing environment to perform a method comprising:
receiving data representative of one or more transaction payments from a cooperating transaction payment processing system component;
validating the transaction payment data according to one or more selected fraud detection protocols; and
responsive to the validation of the transaction payment data initiating at least one service bus environment service and/or application to perform fraud detection.

93. In a modular transaction payment processing system having a service bus environment operable to initiate, manage, and control at least one service bus environment service and/or service bus environment application, a system for fraud detection for a transaction payment comprising:
a service bus service/application container operable to house a service bus environment service and/or-service bus environment application;
a service bus adaptor operable to operatively link a service bus environment service and/or application to a service bus environment service bus; and
a transaction payment fraud detection service bus service/application operable to receive transaction payment data and perform transaction payment fraud detection processing according to one or more selected transaction payment fraud detection processing protocols.

94. The system as recited in claim 93 further comprising a service bus environment program operable to provide one or more instructions to the service bus environment to communicate data between cooperating components of the service bus environment.

95. The system as recited in claim 94 wherein the service bus environment initiates a first service to perform a fraud detection protocol for a transaction payment being processed for transaction payment fraud detection based on card information.

96. The system as recited in claim 94 wherein the service bus environment initiates a second service/application to perform a fraud detection protocol for a transaction payment being processed for transaction payment fraud detection based on account information.

97. The system as recited in claim 96 wherein the service bus environment initiates a third service/application to perform a fraud detection protocol for a transaction payment being processed for transaction payment fraud detection based on geographic information.

98. A system for performing regulatory compliance processing for a transaction payment comprising:
a service bus environment having one or more service bus environment services and/or service bus environment applications operable to perform transaction payment regulatory compliance processing; and
a service bus environment program cooperating with the service bus environment providing instructions to the service bus environment to process transaction payment regulatory compliance data,
wherein the service bus environment is operable to process transaction processing regulatory compliance data from one or more cooperating regulatory compliance processing modules.

99. The system as recited in claim 98 wherein the service bus environment comprises a computing environment.

100. The system as recited in claim 99 wherein the service bus environment comprises a distributed computing environment.

101. The system as recited in claim 100 wherein the service bus environment is a data driven computing application.

102. The system as recited in claim 101 wherein the service bus environment performs at least one transaction payment regulatory compliance function comprising any of reporting completed transaction payments as per at least one selected regulatory compliance protocol, and storing data representative of transaction payment transactions as per at least one selected regulatory compliance protocol.

103. The system as recited in claim 102 further comprising a user interface providing access to the service bus environment to perform the at least one of a transaction payment regulatory compliance function.

104. The system as recited in claim 103 further wherein the at least one of a transaction payment regulatory compliance function is performed by a service bus environment program.

105. A method for performing transaction payment regulatory compliance processing comprising:
receiving data representative of one or more transaction payments from a cooperating transaction payment processing system component;
satisfying one or more regulatory compliance requirements for a transaction payment transaction according to one or more selected transaction payment regulatory compliance protocols; and
responsive to the processing of transaction payment data to satisfy regulatory compliance requirements initiating at least one service bus environment service and/or application to perform transaction payment regulatory compliance processing
wherein the service bus environment is operable to process transaction processing regulatory compliance data from one or more cooperating regulatory compliance processing modules.

106. The method as recited in claim 105 further comprising formatting the transaction payment data into a data format that can be processed by the service bus environment.

107. The method as recited in claim 106 further comprising communicating the transaction payment data to the at least one service bus environment service and/or application via a service bus environment communications network.

108. The method as recited in claim 107 further comprising approving the transaction payment transaction based on passing at least one selected transaction payment regulatory compliance protocol.

109. The method as recited in claim 107 further comprising communicating the results of the transaction payment regulatory compliance processing to cooperating parties comprising any of a bank, customers, and program sponsors through a communications network.

110. The method as recited in claim 109 further comprising tracking at least one transaction payment regulatory compliance event by a service bus environment service and/or application.

111. The method as recited in claim 110 further comprising storing transaction payment regulatory compliance data by a service bus environment service and/or application for subsequent processing.

112. The method as recited in claim 111 further comprising reporting transaction payment regulatory compliance formatted data by a service bus environment service and/or application to cooperating parties comprising any of a bank, a customer, and a program sponsor.

113. A computer readable medium having compute readable instructions to instruct a computing environment to perform a method comprising:
receiving data representative of one or more transaction payments from a cooperating transaction payment processing system component;
satisfying one or more regulatory compliance requirements for a transaction payment transaction according to one or more selected transaction payment regulatory compliance protocols; and
responsive to the processing of transaction payment data to satisfy regulatory compliance requirements initiating at least one service bus environment service and/or application to perform transaction payment regulatory compliance processing.

114. In a modular transaction payment processing system having a service bus environment operable to initiate, manage, and control at least one service bus environment service and/or service bus environment application, a system for transaction payment regulatory compliance processing comprising:
a service bus service/application container operable to house a service bus environment service and/or service bus environment application;
a service bus adaptor operable to operatively link a service bus environment service and/or application to a service bus environment service bus; and
a transaction payment regulatory compliance service bus service/application operable to receive transaction payment data and perform transaction payment regulatory compliance processing according to one or more selected transaction payment regulatory compliance processing protocols.

115. The system as recited in claim 114 further comprising a service bus environment program operable to provide one or more instructions to the service bus environment to communicate data between cooperating components of the service bus environment.

116. A voice-based transaction payment system comprising:
a service bus environment having one or more service bus environment services and/or service bus environment applications operable to perform voice-based transaction payment processing; and
a service bus environment program cooperating with the service bus environment providing instructions to the service bus environment to process voice-based transaction payment data,
wherein the service bus environment is operable to process voice-based transaction payment data from one or more cooperating voice-based transaction processing modules.

117. The system as recited in claim 116 wherein the service bus environment comprises a computing environment.

118. The system as recited in claim 117 wherein the service bus environment comprises a distributed computing environment.

119. The system as recited in claim 118 wherein the service bus environment is a data driven computing application.

120. The system as recited in claim 119 wherein the service bus environment performs at least one voice-based transaction payment processing function comprising any of: receiving a voice command via a telephony communications network for subsequent processing, converting the voice command into a voice XML instruction, and generating a voice response from one or more voice XML computing environment pages.

121. The system as recited in claim 120 further comprising a user interface providing access to the service bus environment to perform the at least one of a voice-based transaction payment processing function.

122. The system as recited in claim 121 further wherein the at least one of a voice-based transaction payment processing function is performed by a service bus environment program.

123. A method for performing voice-based transaction payment processing comprising:
receiving data representative of one or more transaction payments from a cooperating transaction payment processing system component as a voice command;
converting the voice command into a voiced-based mark-up language for processing by a system bus environment voice-based transaction payment processing service/application; and
responsive to the receiving of voice-based transaction payment data initiating at least one service bus environment service and/or application to perform voice-based transaction payment processing,
wherein the service bus environment is operable to process voice-based transaction payment data from one or more cooperating voice-based transaction processing modules.

124. The method as recited in claim 123 further comprising formatting received transaction payment data into a data format that can be processed by the service bus environment.

125. The method as recited in claim 124 further comprising communicating the transaction payment data to the at least one service bus environment service and/or application via a service bus environment communications network.

126. The method as recited in claim 125 further comprising communicating the results of the voice-based transaction payment processing cooperating parties comprising any of a bank, customers, and program sponsors through a communications network.

127. The method as recited in claim 126 further comprising tracking at least one voiced-based transaction payment event by a service bus environment service and/or application.

128. The method as recited in claim 127 further comprising storing voice-based transaction payment data by a service bus environment service and/or application for subsequent processing.

129. The method as recited in claim 128 further comprising reporting voice-based transaction payment formatted data by a service bus environment service and/or application to cooperating parties comprising any of a bank, a customer, and a program sponsor.

130. A computer readable medium having compute readable instructions to instruct a computing environment to perform a method comprising:
receiving data representative of one or more transaction payments from a cooperating transaction payment processing system component as a voice command;
converting the voice command into a voiced-based mark-up language for processing by a system bus environment voice-based transaction payment processing service/application; and
responsive to the receiving of voice-based transaction payment data initiating at least one service bus environment service and/or application to perform voice-based transaction payment processing.

131. In a modular transaction payment processing system having a service bus environment operable to initiate, manage, and control at least one service bus environment service and/or service bus environment application, a system to perform voice-based transaction payment processing comprising:
a service bus service/application container operable to house a service bus environment service and/or service bus environment application;
a service bus adaptor operable to operatively link a service bus environment service and/or application to a service bus environment service bus; and
a voice-based transaction payment service bus service/application operable to receive transaction payment data and perform voice-based transaction payment processing according to one or more selected voice-based transaction processing protocols.

132. The system as recited in claim 131 further comprising a service bus environment program operable to provide one or more instructions to the service bus environment to communicate data between cooperating components of the service bus environment.

133. A zero-sum accounting system for a transaction payment comprising:
a zero-sum accounting engine operable on a plurality of transaction payment to reconcile accounting of a transaction payment transaction between cooperating parties; and
an instruction set providing instructions to the zero-sum accounting engine to process transaction payment data to perform at least one zero-sum accounting protocol,
wherein the zero-sum accounting engine is operable to process transaction processing accounting data from one or more cooperating transaction accounting processing modules.

134. The system as recited in claim 133 further comprising a zero-sum accounting structure having localized relationships between accounts of cooperating transaction payment parties.

135. The system as recited in claim 134 wherein the zero-sum accounting engine comprises a computing environment.

136. The system as recited in claim 135 wherein the zero-sum accounting engine is a data driven computing application operating in a computing environment.

137. The system as recited in claim 136 wherein the zero-sum accounting engine performs at least one zero-sum accounting processing function for a transaction payment comprising any of: aggregating transaction amounts, reconciling completed transactions with transaction accounts, reporting results of reconciliation processing, and performing at least one cash flow method from a selected set of cash flow methods.

138. The system as recited in claim 137 further comprising a user interface providing access to the service bus environment to perform the at least one of zero-sum accounting processing function for a transaction payment.

139. The system as recited in claim 138 further wherein the at least one of a zero-sum accounting processing for a transaction payment function is performed by a service bus environment program.

139. A method for performing zero-sum accounting processing for a transaction payment comprising:
receiving data representative of one or more transaction payments from a cooperating transaction payment processing system component as a voice command;
applying at least one selected zero-sum accounting protocol for a transaction payment to the received transaction payment data ; and
responsive to the receiving of transaction payment data initiating a zero-sum accounting engine to perform transaction payment zero-sum accounting processing,
wherein the zero-sum accounting engine is operable to process transaction processing accounting data from one or more cooperating transaction accounting processing modules.

140. The method as recited in claim 139 further comprising formatting received transaction payment data into a data format that can be processed by the zero-sum accounting engine.

141. The method as recited in claim 139 further comprising communicating the results of the transaction payment zero-sum accounting processing to cooperating parties comprising any of a bank, customers, and program sponsors through a communications network.

142. The method as recited in claim 141 further comprising tracking at least one transaction payment zero-sum accounting event by the zero-sum accounting engine.

143. The method as recited in claim 142 further comprising storing the zero-sum accounting processing data for subsequent processing by cooperating parties of a transaction payment processing system.

144. The method as recited in claim 143 further comprising reporting zero-sum accounting formatted data by the zero-sum accounting engine to cooperating parties comprising any of a bank, a customer, and a program sponsor over a cooperating communications network.

145. A computer readable medium having compute readable instructions to instruct a computing environment to perform a method comprising:
receiving data representative of one or more transaction payments from a cooperating transaction payment processing system component as a voice command;
applying at least one selected zero-sum accounting protocol for a transaction payment to the received transaction payment data; and
responsive to the receiving of transaction payment data initiating a zero-sum accounting engine to perform transaction payment zero-sum accounting processing.
